(19) United States
(12) Patent Application Publication
(10) Pub. No.: US 2012/0118249 A1
(43) Pub. Date: May 17, 2012

(54) AXIAL-PISTON ENGINE, METHOD FOR OPERATING AN AXIAL-PISTON ENGINE, AND METHOD FOR PRODUCING A HEAT EXCHANGER OF AN AXIAL-PISTON ENGINE

(75) Inventors: Ulrich Rohs, Dueren (DE); Dieter Voigt, Aachen (DE)

(73) Assignee: GETAS Gesellschaft fuer thermodynamische Antriebssysteme mbH, Dueren (DE)

(21) Appl. No.: 13/386,569

(22) PCT Filed: Jul. 26, 2010
(86) PCT No.: PCT/DE2010/000876

§ 371 Date: Jan. 23, 2012

(30) Foreign Application Priority Data
Jul. 24, 2009 (DE) 10 2009 034 734.8

(51) Int. Cl. F02B 75/18

(52) U.S. Cl. 123/56.1

(57) ABSTRACT

The aim of the invention is to improve the efficiency of an axial-piston motor comprising at least one compressor cylinder, at least one working cylinder and at least one pressure line guiding the compressed fuel from the compressor cylinder to the working cylinder. To this end, the axial-piston motor is provided with at least one compressor cylinder inlet valve having an annular cover.

The invention relates to an axial-piston engine. The invention also relates to a method for operation of an axial-piston engine and to a method for production of a heat exchanger of an axial-piston engine.

Axial-piston engines are sufficiently known from the state of the art, and are characterized as energy-converting machines, which provide mechanical rotational energy on the output side with the aid of at least one piston, wherein the piston executes a linear oscillatory motion whose alignment is aligned essentially coaxially with the axis of rotation of the rotational energy.

In addition to axial piston engines that are operated, for example, only with compressed air, axial-piston engines to which a combustion agent is supplied are also known. This combustion agent can be made up of a plurality of components, for example a fuel and air, wherein the components are fed, together or separately, to one or more combustion chambers.

In the present case, the term “combustion agent” thus designates any material that participates in the combustion, or is carried with components that participate in the combustion, and which flows through the axial-piston engine. The combustion agent then includes at least a combustible substance or fuel, wherein the term “fuel” in the present context therefore describes any material that reacts exothermally by way of a chemical reaction or other reaction, in particular by way of a redox reaction. In addition, the combustion agent can also have components such as air, for example, which provide materials for the reaction of the fuel or combustion agent.

In particular, axial-piston engines can also be operated under the principle of internal continuous combustion (icc), according to which combustible fuels, i.e., for example fuel and air, are fed continuously to a combustion chamber or to a plurality of combustion chambers.

Moreover, axial-piston engines can work on the one hand with rotating pistons, and correspondingly rotating cylinders, which are moved successively past a combustion chamber.

On the other hand, axial-piston engines can have stationary cylinders, whereby the working medium is then successively distributed to the cylinders according to the desired loading sequence.

For example, icc axial-piston engines having stationary cylinders of this sort are known from EP 1 035 310 A2 and from WO 2009/062473 A2, wherein in EP 1 035 310 A2 an axial-piston engine is disclosed in which the supplying of combustion agent and the removal of exhaust gas are coupled with one another with heat transfer.

The axial-piston engines disclosed in EP 1 035 310 A2 and in WO 2009/062473 A2 have in addition a separation between working cylinders and the corresponding working pistons, and compressor cylinders and the corresponding compressor pistons, wherein the compressor cylinders are provided on the side of the axial-piston engine facing away from the working cylinders. In this respect, a compressor side and a working side can be assigned to such axial-piston engines.

It is understood that the terms “working cylinder,” “working piston” and “working side” are used synonymously with the terms “expansion cylinder,” “expansion piston” and “expansion side” or “expander cylinder,” “expander piston” and “expander side,” as well as synonymously with the terms “expansion stage” or “expander stage,” wherein an “expander stage” or “expansion stage” designates the totality of all “expansion cylinders” or “expander cylinders” located therein.

The task of the present invention is to improve the efficiency of an axial-piston engine.

This task is accomplished by an axial-piston engine with at least one compressor cylinder, with at least one working cylinder and with at least one pressure line, through which compressed combustion agent is conducted from the compressor cylinder to the working cylinder, which is characterized by at least one compressor cylinder inlet valve with a ring-shaped inlet valve cover.

By the fact that the axial-piston engine with at least one compressor cylinder, with at least one working cylinder and with at least one pressure line, through which compressed combustion agent is conducted from the compressor cylinder to the working cylinder has, according to the invention, at least one compressor cylinder inlet valve with a ring-shaped inlet valve cover, a particularly large passage volume can be achieved at the compressor cylinder for a combustion agent, especially for combustion air to be drawn in. In this respect, the combustion air, for example—or another combustion agent—can be sucked into the compressor cylinder with extremely low losses, whereby the efficiency of the axial-piston engine can be improved simultaneously hereby.

Furthermore, an additional installation space with regard to a compressor cylinder head advantageously remains in the middle region of the ring-shaped inlet valve cover for components that otherwise would have to be placed next to the compressor cylinder inlet valve. In this respect the compactness of the axial-piston engine can also be further improved.

A ring-shaped inlet valve cover is not known from the publications cited in the beginning and also no indication can be found therein that such a ring-shaped inlet valve cover could impart advantages to an axial-piston engine.

The compressor cylinder inlet valve with its ring-shaped inlet valve cover can be designed as an actively activated or a passively activated valve in the present case. In the present connection, an actively activated valve is characterized in that an additional drive is used for activation of the valve. This can be, for example, an electric motor drive or an electromagnetic drive for the valve. Likewise it can be a camshaft or cam plate or cam disk. Likewise a pneumatic or hydraulic drive can be used if necessary for active activation. Passively activated valves are opened or closed by the pressure conditions in the environment of the respective valve, wherein appropriate opening and closing forces can be applied in particular by a pressure difference on the valve input side and valve output side. If necessary, the characteristic of the passively activated valves can be influenced by suitable springs and similar bias stresses, which must be additionally overcome, or by suitable configurations in the detail of the respective valves, for example by slopes in the valve cover or adaptation of the size ratios.

In order to be able to place the inlet valve cover particularly advantageously on the cylinder head, a preferred alternative embodiment provides that the inlet valve cover has a three-point holder. By placement of the inlet valve cover on three holding points, it is possible to reduce the danger that the inlet valve cover will be critically misaligned and even jammed with respect to an inlet valve seat. In addition, the inlet valve cover can be moved particularly uniformly during a working movement. Moreover, a three-point holder is very stable and therefore has a very long useful life.

Furthermore, it is advantageous when the inlet valve cover is clamped against an inlet valve seat via at least one spring. Certainly it is known from the application disclosure EP 1 035 310 A2 mentioned at the beginning that a valve cover in a compressor cylinder is pulled by a spring against a valve seat. However, this is not in connection with a ring-shaped inlet valve cover.

In particular, a plurality of springs is not known for clamping of an inlet valve cover, wherein three such springs are ideally provided in connection with the present three-point holder of the inlet valve cover, in order to be able to clamp the inlet valve cover particularly uniformly against the inlet valve seat. Particularly high seal tightness at the compressor cylinder inlet valve can be achieved by such clamping.

In particular, an eccentric spring fastening on an inlet valve cover is not yet known, at least in connection with a compressor cylinder inlet valve of an axial-piston engine. Such an eccentric spring fastening is preferably provided in the present case, however, so that uniform clamping can be guaranteed especially even for large valve diameters.

With regard to a further very advantageous alternative embodiment of an axial-piston engine, it is proposed that an inlet into the compressor cylinder or an outlet from the compressor cylinder be provided inside the ring formed by the inlet valve cover. As already mentioned above, sufficient space still remains in the middle of the ring-shaped inlet valve cover that further components or groups of components of the compressor cylinder can be situated. In particular, an entry to or an exit from the compressor cylinder can be provided there, whereby space available at the compressor cylinder head can be utilized particularly effectively.

Ideally, such an inlet is a water inlet, by means of which water can be applied into the compressor cylinder. Hereby the water can be applied in particular centrally in the compressor cylinder, whereby the water can be intermixed particularly uniformly with combustion air drawn in via the compressor cylinder inlet valve. For example, this is done in connection with an intake stroke motion of a compressor piston. It is understood that other combustion agents can also be applied into the compressor cylinder via the inlet.

In this connection, the task of the present invention is also accomplished cumulatively or alternatively to the aforementioned features by an axial-piston engine with at least one compressor cylinder, with at least one working cylinder and with at least one pressure line, through which compressed combustion agent is conducted from the compressor cylinder to the working cylinder, wherein the axial-piston engine is characterized in that water or water vapor is applied to the compressor cylinder during an intake stroke of a compressor piston situated in the compressor cylinder.

On the one hand, an excellent distribution of the water in the combustion agent is guaranteed hereby. On the other hand, the compression enthalpy modified by the water can be introduced non-critically into the combustion agent, without the energy balance of the entire axial-piston engine being influenced disadvantageously by the application of water. In particular, the compression process of an isothermal compression can be approximated thereby, whereby the energy balance can be optimized during the compression. The proportion of water—depending on the concrete implementation—can be used supplementally for regulation of the temperature in the combustion chamber, and/or also for reduction of pollution by means of chemical or catalytic reactions of the water. Of course, it is also possible to apply water at another place.

Depending on the concrete implementation of the present invention, the application of water can be carried out, for example, by a metering pump. A metering pump can be dispensed with by means of a check valve, since then the compressor piston can also draw in water during its intake stroke through the check valve, which then closes during compression. The latter implementation is especially advantageous if a safety valve, for example a solenoid valve, is also provided in the water supply line in order to prevent leakage when the engine is stopped.

If an outlet is provided on the compressor cylinder inside the ring formed by the inlet valve cover, it is advantageous if the outlet is an outlet valve, since hereby a region subjected to high thermal load around the outlet valve can be cooled particularly well when fresh combustion air is drawn into the compressor cylinder via the compressor cylinder inlet valve.

The task of the invention is also accomplished by an axial-piston engine with at least one compressor cylinder, with at least one working cylinder and with at least one pressure line, through which compressed combustion agent is conducted from the compressor cylinder to the working cylinder, wherein the axial-piston engine is characterized by at least two compressor cylinder outlet valves.

Two compressor cylinder outlet valves impart the particularly great advantage that very short reactions times can be achieved, especially with regard to stroke movements of the outlet valve cover, since correspondingly smaller outlet valves can be provided for the same throughput on the compressor cylinder. Despite the smaller structure of the outlet valves, excellent removal of compressed combustion agent from the compressor cylinder can nevertheless be guaranteed.

In this respect, two or more compressor cylinder outlet valves permit particularly rapid removal, with low friction losses, of compressed combustion agent. Thus the efficiency can be further improved hereby, cumulatively or alternatively. Such an advantageous arrangement of more than one individual compressor cylinder outlet valve on an axial-piston engine also cannot be inferred from the state of the art mentioned at the beginning.

Furthermore, the task of the invention is accomplished by an axial-piston engine with at least one compression cylinder, with at least one working cylinder and with at least one pressure line, through which compressed combustion agent is conducted from the compressor cylinder to the working cylinder, wherein the axial-piston engine is characterized by at least one compressor cylinder outlet valve with a valve cover formed with convexity in the direction of a valve seat, which has less material on its side facing away from the valve seat than on its side facing the valve seat.

In a valve cover formed with convexity, good alignment and excellent sealing can almost always be guaranteed, even if clearance is present relative to a corresponding valve seat. In this respect, this can also increase the efficiency of the present axial-piston engine, since the closing times or opening times are correspondingly short. For example, the valve cover formed with convexity is advantageously configured as a sphere or cone.

If the valve cover formed with convexity advantageously also has less material on its side facing away from the valve cover than on its side facing the valve seat, the valve cover can be constructed with extremely light weight, whereby very short reaction times can be achieved.

The side facing the valve seat can preferably be defined by the maximum diameter of the valve cover perpendicular to the working or actuation direction of the valve cover or perpendicular to the longitudinal extent of the compressor cylinder outlet valve, and thus clearly distinguished from the side facing away from the valve seat.

A preferred alternative embodiment provides that the valve cover, especially of the compressor cylinder outlet valve, is a hemisphere. Because of the hemispherical shape, a valve cover shaped in this way advantageously has a flat bracing face despite a spherical sealing region, for example for a valve cover pressing spring, whereby the valve cover can always be aligned optically relative to a valve seat. Hereby maximum sealing of the compressor cylinder outlet valve can always be ideally achieved. In this connection, it is understood that still further structures, such as a spring seat, for example, can be provided on the side of the valve cover facing away from the sealing region, without deviating from the feature of a flat bracing face and the advantages associated therewith.

Cumulatively or alternatively to the aforesaid features, it is advantageous when the valve cover is of hollow structure, since hereby it can be configured with even lighter weight.

It is understood that the valve cover formed with convexity can be produced from various materials. Advantageously it is made from a ceramic. Ceramic spheres on a compressor cylinder outlet valve are indeed already known from EP 1 035 310 A2, but not in the shape of an advantageous hemisphere.

Cumulatively or alternatively to this, it is advantageous when means for alignment of the valve cover are provided that cooperate with a valve cover pressing spring. On the basis of a purposeful alignment of the valve cover, asymmetries that can have a particularly material-saving effect can be advantageously implemented operationally reliably for the valve cover.

A construction with a valve cover pressing spring in combination with means for alignment of the valve cover can be structurally achieved particularly simply. In addition, by means of such a construction, a fast-acting outlet valve closing device, which in addition can be implemented very cost-effectively, can be provided on the axial-piston engine. For example, the valve cover pressing spring is guided in a stem in a valve cover of the compressor cylinder, so that critical radial deflections of the valve cover pressing spring can be suppressed. Hereby at least indirect alignment of the valve cover can be achieved. Direct alignment can be achieved if the valve cover were to be guided directly itself in similar manner, alternatively or cumulatively. The above embodiments of the compressor cylinder outlet valve can be employed in particular in connection both with passively activated and also with actively activated compressor cylinder outlet valves. Passively activated compressor cylinder outlet valves seem particularly suitable in the present connection, since they can be structurally implemented simply and the pressure conditions in the compressor cylinder permit simple and precise activation of the compressor cylinder outlet valves—but also of the compressor cylinder inlet valves.

According to a further aspect of the invention, an axial-piston engine with a compressor stage comprising at least one cylinder, with an expander stage comprising at least one cylinder, with at least one combustion chamber between the compressor stage and the expander stage is proposed, wherein the axial-piston engine includes a gas exchange valve that oscillates and releases a flow cross section, and the gas exchange valve closes this flow cross section by means of a spring force of the valve spring acting on the gas-exchange exchange valve, and wherein the axial-piston engine is characterized in that the gas exchange valve has an impact spring. Gas exchange valves that are self-actuated, i.e., passively activated or in particular not cam-actuated, which open at an applied pressure difference, can be accelerated so strongly, when the pressure difference present causes a very large opening force, that either the valve spring of the gas exchange valve becomes fully compressed or the valve spring plate or else even a comparable bracing ring strikes another component. Such an impermissible and undesired contact between two components can very quickly lead to destruction of these components. In order to prevent slamming of the valve spring plate effectively, a further spring designed as an impact spring is therefore advantageously provided, which dissipates excess kinetic energy of the gas exchange valve and brakes the gas exchange valve to a standstill.

In particular, the impact spring can have a shorter spring length than a spring length of the valve spring. Provided the two springs, the valve spring and the impact spring, have a common bearing face, the impact spring is advantageously designed such that the spring length of the installed valve spring is always shorter than the spring length of the impact spring, so that the valve spring, upon opening of the gas exchange valve, initially applies exclusively the forces necessary to close the gas exchange valve and, after the maximum provided valve stroke has been reached, the impact spring comes into contact with the gas exchange valve, in order immediately to prevent further opening of the gas exchange valve.

Cumulatively to this, the spring length of the impact spring can correspond to the spring length of the valve spring decreased by a valve stroke of the gas exchange valve. Expediently and advantageously, the circumstance is used in this case that the difference of the spring lengths of the two springs corresponds precisely to the amount of the valve stroke.

In this case the term “valve stroke” denotes the stroke of the gas exchange valve from which the flow cross section released by the gas exchange valve reaches approximately a maximum. A plate valve commonly used in engine construction usually has a linearly increasing geometric flow cross section at small degree of opening, which then merges into a line with constant value upon further opening of the valve. The maximum geometric opening cross section is usually reached when the valve stroke reaches 25% of the internal valve seat diameter. The internal valve seat diameter is the smallest diameter present at the valve seat.

The term “spring length” in this case denotes the maximum possible length of the impact spring or of the valve spring in the installed state. Thus the spring length of the impact spring corresponds exactly to the spring length in the untensioned state and the spring length of the valve spring exactly to the length that the valve spring has in the installed state with the gas exchange valve closed.

Alternatively or cumulatively to this, it is further proposed that the spring length of the impact spring correspond to a height of a valve guide increased by a spring travel of the impact spring. This has the advantage that a valve guide, but also any other fixed component that can come into contact with a moving component of the valve control system, absolutely does not come into contact with a moving component of the valve control system, since the impact spring, even upon reaching the provided spring travel, is absolutely not compressed so much that contact occurs.

The term “spring travel” in this case denotes the spring length minus the length of the spring that exists at maximum load. The maximum load in turn is defined via the computed design of the valve drive, including a factor of safety. Thus the spring travel is exactly the length by which the spring is compressed when the maximum load occurring in operation of the axial-piston engine or the maximum valve stroke provided in operation of the axial-piston engine occurs during abnormal load. The maximum valve stroke in this context denotes the valve stroke defined above plus a stroke of the gas exchange valve at which contact between a moving component and a fixed component just occurs.

Any other component that can come into contact with moving parts of the valve drive can take the place of a valve guide.

Furthermore, upon reaching the spring travel of the impact spring, the impact spring may have a potential energy that corresponds to the maximum operationally caused kinetic energy of the gas exchange valve upon release of the flow cross section. Precisely upon satisfaction of this physical or kinetic condition, braking of the gas exchange valve is advantageously achieved precisely when contact between two components is just not made. As explained above, the maximum operationally caused kinetic energy is the kinetic energy of the gas exchange valve that can occur for the computed design of the valve drive, including a factor of safety. The maximum operationally caused kinetic energy is caused by the maximum pressures or pressure differences present at the gas exchange valve, whereby the gas exchange valve is accelerated on the basis of its mass and after decay of this acceleration acquires a maximum speed of motion. Excess kinetic energy stored in the gas exchange valve is absorbed via the impact spring, so that the impact spring becomes compressed and has potential energy. Upon reaching the spring travel of the impact spring or upon maximum provided compression of the impact spring, dissipation of the kinetic energy of the gas exchange valve or of the valve group to the amount of zero is advantageous, so that contact between two components just does not occur. The term “maximum operationally caused kinetic energy” therefore also encompasses the kinetic energies of all components moved with the gas exchange valve, such as, for example, the valve keys, valve spring plates or valve springs.

For accomplishment of the task set in the introduction, an axial-piston engine with a compressor stage comprising at least one cylinder, with an expander stage comprising at least one cylinder, with at least one combustion chamber between the compressor stage and the expander stage is further proposed, wherein the axial-piston engine is characterized in that at least one cylinder has at least one gas-exchange valve of a light metal. Light metal, especially during use of moving components, reduces the inertia of the components consisting of this light metal and, because of its low density, can reduce the friction loss of the axial-piston engine to the effect that the control drive of the gas-exchange valves is designed to correspond to the lower inertial forces. The reduction of the friction loss by use of components of light metal leads in turn to a smaller overall loss of the axial-piston engine and simultaneously to an increase of the overall efficiency.

Cumulatively to this, it is proposed that the light metal be aluminum or an aluminum alloy, especially dural. Aluminum, especially a hard or very hard aluminum alloy, offers special advantages for a configuration of a gas-exchange valve, since in this case not only the weight of a gas-exchange valve via the density of the material but also the strength of a gas-exchange valve can be increased or maintained at a high level. Obviously it is also conceivable that the material titanium or magnesium or an alloy of aluminum, titanium and/or magnesium can be used instead of aluminum or an aluminum alloy. In particular, a correspondingly lightweight gas-exchange valve can follow load changes correspondingly faster than can be done, already on the basis of the greater inertia, by a heavy gas-exchange valve.

In particular, the gas-exchange valve can be an inlet valve. The advantage of a lightweight gas-exchange valve and of an associated lower mean friction pressure or a smaller friction loss of the axial-piston engine can be implemented especially during use of an inlet valve of a light material, since low temperatures, at a sufficient distance from the melting temperature of aluminum or aluminum alloys, are present at this place of the axial-piston engine. On the other hand, it is understood that the advantages of a gas-exchange valve of a light metal can also be employed correspondingly advantageously, cumulatively to the configurations mentioned above in relation to the compressor cylinder outlet valves and the compressor cylinder inlet valves.

According to a further aspect of the invention, an axial-piston engine with a compressor stage comprising at least one cylinder, with an expander stage comprising at least one cylinder and with at least one combustion chamber between the compressor stage and the expander stage is proposed, which is characterized in that the compressor stage has a stroke volume different from the expander stage.

In particular, it is proposed cumulatively hereto that the stroke volume of the compressor stage be smaller than the stroke volume of the expander stage.

Furthermore, a method for operation of an axial-piston engine with a compressor stage comprising at least one cylinder, with an expander stage comprising at least one cylinder, with at least one combustion chamber between the compressor stage and the expander stage is proposed, which is characterized in that a combustion agent or a burned combustion agent present as exhaust gas is expanded during expansion in the expander stage with a greater pressure ratio than a pressure ratio existing during compression in the compressor stage.

The thermodynamic efficiency of the axial-piston engine can be maximized particularly advantageously by these measures in each instance, since, in contrast to the state of the art heretofore, as in WO 2009/062473, for example, the theoretical thermodynamic potential of a work cycle implemented in an axial-piston engine can be utilized to the maximum by the prolonged expansion permitted hereby. In an engine drawing from the environment and exhausting into this same environment, the thermodynamic efficiency due to this measure reaches its maximum efficiency in this respect when the expansion takes place up to the pressure of the environment.

Therefore a method for operation of an axial-piston engine is further proposed, by means of which the combustion agent is expanded in the expander stage approximately up to the pressure of an environment.

By “approximately”, an environmental pressure raised at the maximum by the amount of the mean friction pressure of the axial combustion engine is meant. Compared with expansion up to the amount of the mean friction pressure, expansion up to the exact environmental pressure does not bring about any substantial advantage in efficiency at a mean friction pressure different from 0 bar. The amount of the mean friction pressure can be interpreted as a pressure that is constant on average acting on the piston, wherein the piston is to be considered as free of forces when the cylinder internal pressure acting on the top side of the piston is equal to the environmental pressure acting on the bottom side of the piston plus the mean friction pressure. Therefore a more favorable overall efficiency of a combustion engine is already achieved upon reaching a relative expansion pressure that lies at the level of the mean friction pressure.

Advantageously, an axial-piston engine for implementation of this advantage can be further designed in such a way that an individual stroke volume of at least one cylinder of the compressor stage is smaller than the individual stroke volume of at least one cylinder of the expander stage. In particular, it is conceivable, by means of a large individual stroke volume of the cylinders of the expander stage, in the case that the numbers of cylinders of the expander stage and of the compressor stage are to remain identical, to influence the thermodynamic efficiency by exerting a favorable influence on the surface-to-volume ratio, whereby smaller losses of heat in the wall are achieved in the expander stage. In this case it is understood that this configuration is advantageous for an axial-piston engine with a compressor stage comprising at least one cylinder, with an expander stage comprising at least one cylinder and with at least one combustion chamber between the compressor stage and the expander stage, even independently of the other features of the present invention.

Alternatively or cumulatively, it is also proposed that the number of cylinders of the compressor stage be equal to or smaller than the number of cylinders of the expander stage.

In addition to the above advantages, the mechanical efficiency of the axial-piston engine and thus also the overall efficiency of the axial-piston engine can be maximized by the choice of a suitable number of cylinders, especially a decreased number of cylinders, with identical individual stroke volume of a cylinder of the expander and compressor stages, in that at least one cylinder of the compressor stage is omitted for achievement of a prolonged expansion and thus the friction loss of the omitted cylinder likewise no longer has to be applied. Some imbalances that could be caused by such an asymmetry of the arrangement of pistons or cylinders can be tolerated under certain circumstances or prevented by supplementary measures.

The task of the present invention is accomplished, cumulatively or alternatively to the other features of the present invention, by an axial-piston engine with a combustion agent supply system and an exhaust gas removal system that are coupled with one another with heat transfer, which axial-piston engine is characterized by at least one heat exchanger insulation system. In this way it is possible to ensure that as much thermal energy as possible remains in the axial-piston engine and is transferred back to the combustion agent by way of the heat exchanger or heat exchangers.

In this connection, it is understood that the heat exchanger insulation does not necessarily have to completely surround the heat exchangers, since some waste heat can possibly also be used advantageously at a different location in the axial-piston engine. However, the heat exchanger insulation should be provided in particular toward the outside.

Preferably, the heat exchanger insulation is designed so that it leaves a maximum temperature gradient between the heat exchanger and the surroundings of the axial-piston engine of 400° C., in particular of at least 380° C. In particular, as the transfer of heat progresses, i.e., toward the compressor side, the temperature gradient can then quickly become significantly smaller. Cumulatively or alternatively to this, the heat exchanger insulation can preferably be designed so that the exterior temperature of the axial-piston engine in the area of the heat exchanger insulation does not exceed 500° C. or 480° C. In this way it is ensured that the quantity of energy lost through heat radiation and heat conduction is reduced to a minimum, since the losses rise disproportionately at even higher temperatures or temperature gradients. Furthermore, the maximum temperature or maximum temperature gradient occurs only at a small location, since otherwise the temperature of the heat exchanger decreases more and more toward the compressor side.

Preferably the heat exchanger insulation includes at least one component made of a material that differs from the heat exchanger. This material can then be designed optimally for its task as insulation, and can comprise for example asbestos, asbestos substitute, water, exhaust gas, combustion agent or air, wherein the heat exchanger insulation should have a housing in the case of fluid insulation materials, in particular in order to minimize heat removal through material movement, while in the case of solid insulation materials a housing can be provided for stabilization or as protection. In particular, the housing can be formed from the same material as the jacket material of the heat exchanger.

Furthermore, the task of the invention is also accomplished by an axial-piston engine with a combustion agent supply system and an exhaust gas removal system that are coupled with one another with heat transfer, wherein the axial-piston engine has at least two heat exchangers.

Especially with regard to a plurality or at least two compressor cylinder outlet valves, particularly rapid and good removal of exhaust gases can be guaranteed when these exhaust gases can be removed by being distributed to at least two heat exchangers. An increase of the efficiency can also be achieved hereby. In this respect, the provision of more than one heat exchanger in known axial-piston engines can also be particularly advantageous.

Although two heat exchangers initially lead to a greater expense and more complex flow conditions, the use of two heat exchangers makes possible significantly shorter paths to the heat exchanger and a more favorable energy arrangement of the latter. This surprisingly allows the efficiency of the axial-piston engine to be increased significantly.

This is true in particular for axial-piston engines with stationary cylinders in which the pistons work in each instance, in contrast to axial-piston engines in which the cylinders and therefore the pistons also rotate around the axis of rotation, since the latter arrangement needs only one exhaust gas line, alongside which the cylinders are guided.

Preferably, the heat exchangers are positioned essentially axially, wherein the term “axially” in the present context designates a direction parallel to the main axis of rotation of the axial-piston engine, or parallel to the axis of rotation of the rotational energy. This allows an especially compact and therefore energy-saving design, which is also true in particular if only one heat exchanger is used, but especially if an insulated heat exchanger is used.

If the axial-piston engine has at least four pistons, then it is advantageous if the exhaust gases from at least two adjacent pistons are conducted into one heat exchanger, in each instance. In this way, the paths between piston and heat exchanger for the exhaust gases can be minimized, so that losses in the form of waste heat that cannot be recovered by way of the heat exchangers can be reduced to a minimum.

The latter can still be achieved even if the exhaust gases from three adjacent pistons are conducted into one common heat exchanger, in each instance.

On the other hand, it is also conceivable that the axial-piston engine comprises at least two pistons, wherein the exhaust gases from each piston are conducted into a heat exchanger of their own. In this respect, it can be advantageous—depending on the concrete implementation of the present invention—if a heat exchanger is provided for each piston. It is true that this leads to an increased construction expense; but on the other hand, the heat exchangers can each be smaller, and therefore possibly of simpler construction, whereby the axial-piston engine as a whole is built more compactly and thus is subject to smaller losses. In particular with this design, but also if a heat exchanger is provided for every two or more pistons, the respective heat exchanger can—if necessary—be integrated into the spandrel between two pistons, whereby the entire axial-piston engine can be designed correspondingly compactly.

According to another aspect of the invention, an axial-piston engine with a compressor stage comprising at least one cylinder, with an expander stage comprising at least one cylinder, and with at least one heat exchanger is proposed, wherein the heat-absorbing part of the heat exchanger is situated between the compressor stage and the combustion chamber and the heat-emitting part of the heat exchanger is situated between the expander stage and an environment, and wherein the axial-piston engine is characterized by the fact that the heat-absorbing and/or the heat-emitting part of the heat exchanger has, downstream and/or upstream, means for applying at least one fluid.

The application of a fluid into the stream of combustion agent can contribute to an increase in the transfer capacity of the heat exchanger, for example since the specific heat capacity of the stream of combustion agent can be adjusted to the specific heat capacity of the exhaust gas stream, through the application of a suitable fluid, or else can be increased beyond the specific heat capacity of the exhaust gas stream. The transfer of heat from the exhaust gas stream to the combustion agent stream influenced thereby, for example advantageously, contributes to the fact that a higher quantity of heat can be coupled into the combustion agent stream and thus into the working cycle while the construction size of the heat exchanger remains the same, whereby the thermodynamic efficiency can be increased. Alternatively or cumulatively, a fluid can also be applied to the exhaust gas stream. The applied fluid in this case can be for example a necessary aid for a downline exhaust gas post-treatment, which can be mixed ideally with the exhaust gas stream by a turbulent flow formed in the heat exchanger, so that a downline exhaust gas post-treatment system can thus be operated with maximum efficiency.

“Downstream” designates in this case the side of the heat exchanger from which the respective fluid emerges, or that part of the exhaust gas line or of the pipework carrying the combustion agent into which the fluid enters after leaving the heat exchanger.

By analogy to this, “upstream” designates the side of the heat exchanger into which the particular fluid enters, or that part of the exhaust gas line or of the pipework carrying the combustion agent from which the fluid enters into the heat exchanger.

In this respect, it does not matter whether the application of the fluid takes place immediately in the near spatial vicinity of the heat exchanger, or whether the application of the fluid takes place at a greater spatial distance.

Water and/or combustible substance for example can be applied appropriately as fluid. This has the advantage that the combustion agent stream has on the one hand the previously described advantages of an increased specific heat capacity through the application of water and/or combustible substance, and on the other hand that the mixture can be prepared already in the heat exchanger or ahead of the combustion chamber and the combustion can take place in the combustion chamber with a combustion air ratio of the greatest possible local homogeneity. This also has in particular the advantage that the combustion behavior is marked only very slightly or not at all with efficiency-degrading, incomplete combustion.

For another configuration of an axial-piston engine, it is proposed that a water trap be situated in the heat-emitting part of the heat exchanger or downstream from the heat-emitting part of the heat exchanger. Because of the reduced temperature existing at the heat exchanger, vaporous water could condense out and damage the subsequent exhaust gas line by corrosion. Damage to the exhaust gas line can be advantageously reduced or prevented through this measure.

In addition, a method for operating an axial-piston engine with a compressor stage comprising at least one cylinder, with an expander stage comprising at least one cylinder, with at least one combustion chamber between the compressor stage and the expander stage and with at least one heat exchanger is proposed, wherein the heat-absorbing part of the heat exchanger is situated between the compressor stage and the combustion chamber and the heat-emitting part of the heat exchanger is situated between the expander stage and an environment, and wherein the method is characterized by the fact that at least one fluid is applied to the combustion agent stream flowing through the heat exchanger and/or to the exhaust gas stream flowing through the heat exchanger. It is hereby possible—as already shown above—to improve the efficiency-enhancing transfer of heat from an exhaust gas stream being conducted into an environment into a combustion agent stream, by increasing the specific heat capacity of the combustion agent stream through the application of a fluid, and thus also increasing the flow of heat to the combustion agent stream. The regenerative coupling of an energy stream into the working cycle of the axial-piston engine in this case can in turn bring about an increase in efficiency, in particular an increase in the thermodynamic efficiency, when the process is carried out appropriately.

Advantageously, the axial-piston engine is operated in such a way that water and/or combustible substance are applied. The result of this procedure is that the efficiency in turn, in particular the efficiency of the combustion process, can be increased through ideal mixing in the heat exchanger and ahead of the combustion chamber.

Combustible substance can likewise be applied to the exhaust gas flow, if this is expedient for an exhaust gas aftertreatment, so that the exhaust gas temperature can be further increased in the heat exchanger or after the heat exchanger. If necessary, postcombustion, which aftertreats the exhaust gas in an advantageous manner and minimizes pollutants, can also be carried out in this way. Heat released in the heat-emitting part of the heat exchanger could thus also be used indirectly for further warming of the combustion agent stream, so that the efficiency of the axial-piston engine is hardly influenced negatively thereby.

In order to further implement this advantage, it is further proposed that the fluid be applied downstream and/or upstream from the heat exchanger.

Cumulatively or alternatively to this, separated water can be applied back into the combustion agent stream and/or the exhaust gas stream. In the most favorable case, a closed water circuit is thereby realized, to which no additional water needs to be supplied from outside. Thus an additional advantage arises from the fact that a vehicle equipped with an axial-piston engine of this construction does not have to be refilled with water, in particular not with distilled water.

Advantageously, the application of water and/or combustible substance is stopped at a defined point in time before the axial-piston engine comes to a stop, and the axial-piston engine is operated until it comes to a stop without application of water and/or fuel. The water, possibly harmful for an exhaust gas line, which can be deposited in the exhaust gas line, in particular when the latter cools, can be avoided by this method. Advantageously, any water is also removed from the axial-piston engine itself before the axial-piston engine comes to a stop, so that damage to components of the axial-piston engine by water or water vapor, especially during the stoppage, is not promoted.

The task of the invention is also accomplished by an axial-piston engine with at least one compressor cylinder, with at least one working cylinder and with at least one pressure line, through which compressed combustion agent is conducted from the compressor cylinder to the working cylinder, which is characterized by a combustion agent reservoir in which compressed medium can be stored temporarily.

Increased power can be called for, particularly briefly, through such a combustion agent reservoir, without a correspondingly increased quantity of combustion agent first having to be provided by means of the compressors. This is of advantage in particular if the compressor pistons of the compressor are directly connected to working pistons, since an increase in combustion agent, which can otherwise ultimately be achieved only by an increase in fuel, can then be supplied merely by increased work output. In this respect, fuel can already be saved thereby.

The combustion agent stored in the combustion agent reservoir can also be used for example for starting procedures of the axial-piston engine.

Preferably, the combustion agent reservoir is provided between the compressor cylinder and a heat exchanger, so that the combustion agent, in particular air provided for the combustion, is temporarily stored in the combustion agent reservoir still cold, or without yet having extracted energy from the heat exchanger. This has a positive effect on the energy balance of the axial-piston engine, as can be seen directly.

It is advantageous, in particular for longer service life, if a valve is situated between the compressor cylinder and the combustion agent reservoir, and/or between the combustion agent reservoir and the working cylinder. In this way, the danger of leakage can be minimized. In particular, it is of advantage if the combustion agent reservoir can be separated from the pressure line via a valve, or from the assemblies that carry combustion agent during normal operation, by means of a valve. In this way, the combustion agent can be stored in the combustion agent reservoir free of influence from the other operating conditions of the axial-piston engine.

Furthermore, it is also advantageous, independent of the other features of the present invention, if the pressure line between the compressor cylinder and the working cylinder has a valve, so that the supplying of combustion agent from the combustion agent reservoir can be stopped operationally reliably, in particular in situations in which no combustion agent is needed, as is the case for example when stopped at a traffic light or during braking procedures, even if compressed combustion agent is still being made available by the compressor because of a motion of the axial-piston engine. In particular, a corresponding interruption can then be carried out and the combustion agent made available by the compressor can immediately go directly into the combustion agent reservoir, in order to then be available immediately and without delay for example for driving off and acceleration processes.

It is understood in this connection that—depending on the concrete embodiment of the axial-piston engine—a plurality of pressure lines can also be provided, which can be appropriately blocked or connected to a combustion agent reservoir, individually or together.

A very advantageous alternative embodiment provides at least two such combustion fuel reservoirs, whereby differing operating states of the axial-piston engine can be regulated with even greater differentiation.

If the at least two combustion agent reservoirs are charged with different pressures, operating states within the combustion chamber can be influenced especially quickly, without needing for example to allow for delays due to an inherent response behavior of regulating valves. In particular, it is possible that the charging times for the reservoirs can be minimized, and in particular that combustion agent can be stored already even at low pressures, while at the same time another reservoir is present that contains combustion agent under high pressure.

Especially varied and intertwined regulation options can accordingly be achieved, if there is a pressure regulating system that defines a first lower pressure limit and a first upper pressure limit for the first combustion agent reservoir, and a second lower pressure limit and a second upper pressure limit for the second combustion agent reservoir, within which a combustion agent reservoir is pressurized, wherein the first upper pressure limit is preferably lower than the second upper pressure limit and the first lower pressure limit is preferably lower than the second lower pressure limit. In particular, the combustion agent reservoirs used can be operated at different pressure intervals, whereby the energy provided by the axial-piston engine in the form of combustion agent pressure can be used even more effectively.

In order to be able to realize for example an especially rapid response behavior in the axial-piston engine, in particular with regard to a very broad spectrum of work, it is advantageous if the first upper pressure limit is lower than or equal to the second lower pressure limit. By means of pressure intervals chosen in this way, an especially broad pressure range can be made available advantageously.

As explained already in detail above, water can be applied to the axial-piston engine. However, this involves the risk that corrosive processes will be promoted—in particular in areas in which combustion products are already present. In order to prevent the latter, independently of the other features of the present invention an axial-piston engine with at least one compressor cylinder, with at least one working cylinder and with at least one pressure line through which compressed combustion agent is conducted from the compressor cylinder to the working cylinder is proposed, wherein water is applied at some location to the axial-piston engine as combustion agent, i.e., as a material running through the combustion chamber, and which is characterized in that the application of water is stopped before the end of operation of the axial-piston engine and the axial-piston engine is operated for a defined period of time without application of water.

It is understood that the time period is chosen as short as possible, since a user would not wish to wait unnecessarily until the engine stops running, and since the engine is actually no longer needed during this time. On the other hand, the time period is chosen long enough so that the water can be adequately removed, in particular from the areas that are hot or in contact with combustion products. During this time period, combustion agent reservoirs can be charged for example. Also during this time, other shut-down processes can be performed on a motor vehicle, such as for example operationally reliable closing of all windows, wherein the energy supplied by the engine can still be used to this end, which in the final analysis relieves a battery.

In this case, the application of water can be made on the one hand directly into the combustion chamber. On the other hand, the water can be mixed beforehand with combustion agent, which can occur for example during or prior to the compression, as was already explained above as an example. A mixing with combustion air or else with combustible substance or other combustion agents can also take place at a different location.

The task explained initially is also accomplished—especially in distinction relative to WO 2009/062473 A2—by an axial-piston engine with a compressor stage comprising at least one cylinder, with an expander stage comprising at least one cylinder, with at least one combustion chamber between the compressor stage and the expander stage, with at least one control piston as well as a channel between the combustion chamber and the expander stage, wherein the control piston and the channel have a flow cross section with a main flow direction released by movement of the control piston and the control piston has a guide face parallel to the main flow direction and/or an impact face perpendicular to the main flow direction, and wherein the control piston as well as the channel has a flow cross section released by movement of the control piston and the movement of the control piston takes place along a longitudinal axis of the control piston and the control piston has a guide face and/or an impact face at an acute angle to the longitudinal axis of the control piston.

Usually a charge exchange between two components of a combustion engine encumbered with volume is connected through a throttling point, with flow losses. Such a throttling point, which in the present situation is formed by the channel and the control piston, causes a loss of efficiency due to these flow losses. The fluidically favorable configuration of this channel and/or of the control piston therefore brings about an increase in efficiency.

Accordingly, a guide face of the control piston aligned parallel to the main flow direction has the advantage of preventing flow losses and maximizing the efficiency. In particular, when the flow is structured specifically such that it does not take place perpendicular to the longitudinal axis of the control piston, it is possible, by a guide face aligned at an acute angle to the longitudinal axis of the control piston, for the guide face to be at a favorable angle relative to a flow streaming over this guide face. Advantageously, the efficiency of the axial-piston engine is also increased by this measure, in that the flow losses at the guide face or at the control piston are minimized.

In the present case, “main flow direction” means the flow direction of the combustion agent through the channel, which is measurable and also graphically representable for laminar or even for turbulent flow of the combustion agent. The feature “parallel” therefore relates to this main flow direction and is to be understood in the mathematically geometric sense, wherein a guide face of a control piston parallel to the main flow direction absolutely does not absorb any momentum due to the flow of the combustible material or absolutely does not change the momentum of the flow.

Provided the control piston has reached a position in which the control piston closes the released flow cross section, this impact face formed perpendicular to the main flow direction is advantageously positioned with a minimum surface relative to the combustion chamber, so that combustion agent present in this combustion chamber also brings about a minimum heat flow into the control piston. Thus, by this impact face with minimum size relative to the main flow direction, the smallest possible heat losses at the wall are also achieved, whereby the thermodynamic efficiency of the axial-piston engine is maximized in turn.

Similarly to the guide face already described above, the impact face can in turn be situated by means of the acute angle and placed in such a way in the flow of combustion agent that the impact face, provided the flow does not take place perpendicular to the control piston or to the longitudinal axis of the control piston, has a minimum surface relative to the flow. An impact face designed to be minimum in turn imparts the advantage that heat losses at the wall are reduced on the one hand and that unfavorable deflections of the flow, with formation of vortices, are minimized and the thermodynamic efficiency of the axial-piston engine is correspondingly maximized.

The guide face and/or the impact face can be a planar face, a spherical face, a cylindrical face or a conical face. A planar configuration of the guide face and/or of the impact face imparts the advantage that, on the one hand, the control piston can be produced particularly simply and cost effectively and that, on the other hand, a sealing face cooperating with the guide face can also be designed with simple construction and a maximum sealing effect takes place at this guide face. A spherical configuration of the guide face and/or of the impact face further imparts the advantage that this guide face is geometrically adapted particularly well to the channel following it, provided the channel also has a circular or else even elliptical cross section. Thus no undesired breakaway flows or turbulences develop at the transition from the control piston or from the guide face of the control piston to the channel. Likewise, a cylindrical guide face and/or impact face can implement the advantage that a flow with prevention of flow breakaways or turbulences can take place at a transition between the control piston and the channel or else even a transition between the control piston and the combustion chamber. Alternatively, a conical face on the guide face and/or on the impact face can also be advantageous, provided the channel following the control piston has a cross section that is variable over the length of the channel. Should the channel be formed as a diffusor or as a nozzle, the flow can again take place without breakaway or turbulences, because of a conically designed guide face on the control piston. It is understood that every measure explained above inherently has or can have an efficiency-maximizing effect, even independently of the other measures.

The axial-piston engine can have a guide-face sealing face between the combustion chamber and the expander stage, wherein the guide-face sealing face is formed parallel to the guide face and cooperates with the guide face at a top dead point of the control piston. Since the control piston also has a sealing effect at its top dead point, the guide-face sealing face is advantageously formed such that it cooperates over a large area with the guide face at the top dead point of the control piston and thus an optimum possible sealing effect takes place. The maximum sealing effect of the guide-face sealing face is then obtained when every point of the guide-face sealing face has the same distance to the guide face, preferably zero distance to the guide face. A guide-face sealing face formed complementarily to the guide face satisfies these requirements regardless of which geometry the guide face has.

Cumulatively hereto, it is proposed that the guide-face sealing face merge on the channel side into a surface perpendicular to the longitudinal axis of the control piston. In a very simple design, the transition of the guide-face sealing face into a surface standing perpendicular to the longitudinal axis of the control piston can also consist of a sharp bend, whereby the flow streaming over the guide-face sealing face can break away at this sharp bend or at this overhang, so that the flow of combustion agent can pass over with the least possible flow losses into the channel following the control piston.

Alternatively or cumulatively to the above features, it is proposed that the axial-piston engine have a stem-sealing face between the combustion chamber and the expander stage, wherein the stem-sealing face is formed parallel to the longitudinal axis of the control piston and cooperates with a surface of a stem of the control piston. Provided the control piston reaches its top dead point, not only does the control piston have the task of sealing relative to the combustion chamber but sealing also takes place advantageously relative to the expander stage, as takes place by the interaction of the stem of the control piston and the corresponding stem-sealing face. Hereby losses due to leakage via the control piston are further reduced, whereby the overall efficiency of the axial-piston engine can in turn be maximized.

Furthermore, it is proposed that the guide face, the impact face, the guide-face sealing face, the stem-sealing face and/or the surface of the stem of the control piston have a reflective surface. Since each of these surfaces can be in contact with combustion agent, a flow of heat in the wall and therefore an efficiency loss can also take place via each of these faces. A reflective surface therefore prevents unnecessary losses due to heat radiation and therefore imparts the advantage of increasing the thermodynamic efficiency of the axial-piston engine correspondingly.

The task mentioned at the beginning is also accomplished by a method for production of a heat exchanger of an axial-piston engine which has a compressor stage comprising at least one cylinder, an expander stage comprising at least one cylinder and at least one combustion chamber between the compressor stage and the expander stage, wherein the heat-absorbing part of the heat exchanger is situated between the compressor stage and the combustion chamber and the heat-emitting part of the heat exchanger is situated between the expander stage and an environment, wherein the heat exchanger includes at least one pipe wall dividing the heat-emitting part from the heat-absorbing part of the heat exchanger to separate two streams of material, and wherein the production process is characterized in that the pipe is situated in at least one matrix consisting of a material corresponding to the pipe, and connected materially and/or frictionally to this matrix.

The use of a heat exchanger in an axial-piston engine described above can lead to disadvantages through the occurrence of especially high temperature differences between the input and between the output of the heat exchanger on the one hand and between the heat-absorbing and heat-emitting part of the heat exchanger on the other hand, due to damage to the material that limits the service life. In order to counter thermal stresses that result from this and losses of combustion agent or exhaust gas that occur due to damage, with appropriate configuration, according to the proposal described above, a heat exchanger can be produced advantageously almost exclusively of only one material at its points that are subject to a critical stress. Even if the latter is not the case, material stresses are advantageously reduced through the solution described above.

It is understood that a solder or other means used for fixing or mounting the heat exchanger can consist of a different material, especially when regions with a high thermal stress or with a high seal tightness requirement are not in question.

The use of two or more materials with the same thermal expansion coefficients is also conceivable, whereby the occurrence of thermal stresses in the material can be countered in similar manner.

To construct a material and/or frictional connection between the pipe and the matrix, it is further proposed that the material connection between the pipe and the matrix be made by welding or soldering. The seal tightness of a heat exchanger is ensured in a simple manner and especially advantageously by a method of this sort. In this case it is again also possible to use a material corresponding to the pipe or to the matrix as the welding or soldering material.

Alternatively or cumulatively to this, the frictional bond between the pipe and the matrix can also be accomplished by shrinking. This in turn has the advantage that thermal stresses between the pipe and the matrix can be prevented, since the use of a material that is different from the material of the pipe or of the matrix, for example, in a materially bonded connection, is avoided. The corresponding connection can then also be made rapidly and operationally reliably.

Additional advantages, objectives and properties of the present invention will be explained on the basis of the following description of the enclosed drawing, in which examples of various assemblies of axial-piston engines are depicted.

The figures show the following:

FIG. 1 a schematic sectional view of an arrangement of an inlet valve and an outlet valve on a cylinder head of a compressor cylinder of an axial-piston engine;

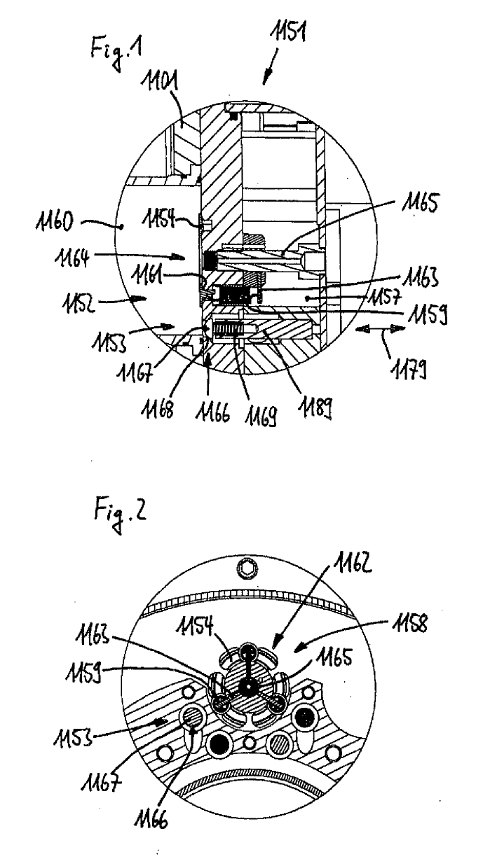

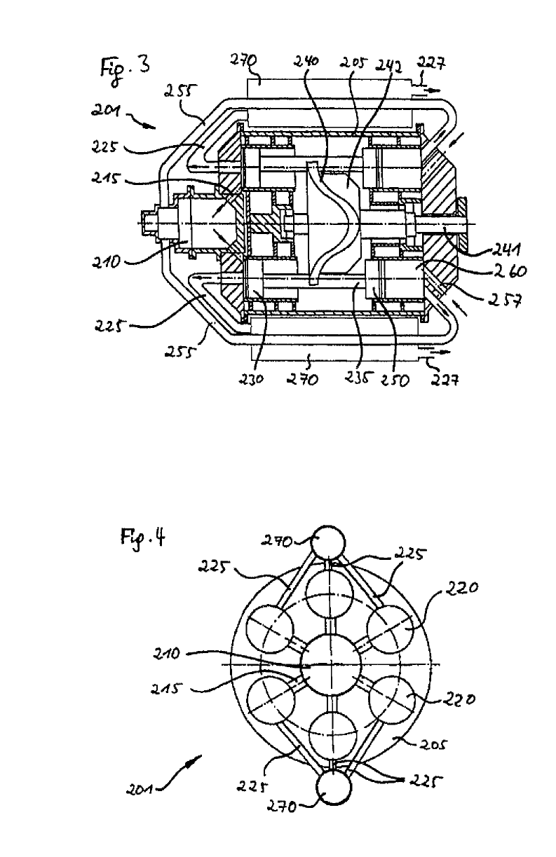

FIG. 2 a schematic partly cutaway top view—seen in the direction of the compressor cylinder—of the arrangement according to FIG. 1;

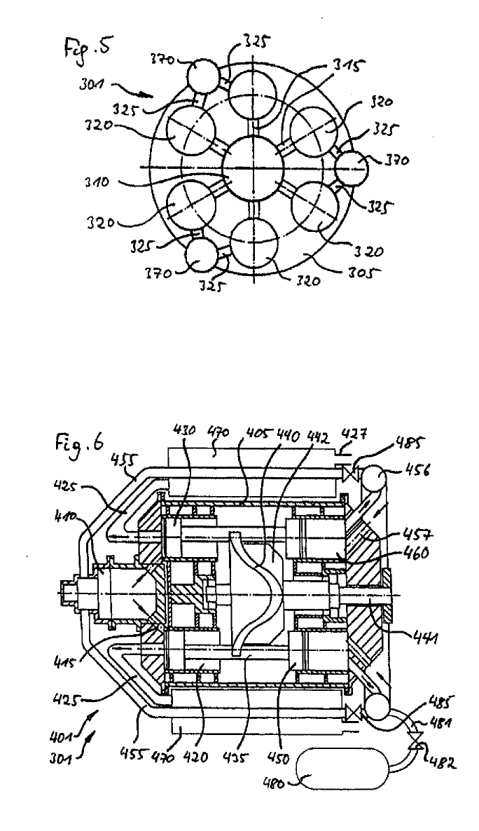

FIG. 3 a schematic sectional view of an axial-piston engine with two heat exchangers, on which the assemblies of FIGS. 1 and 2 can be advantageously used;

FIG. 4 a schematic top view of the axial-piston engine according to FIG. 3;

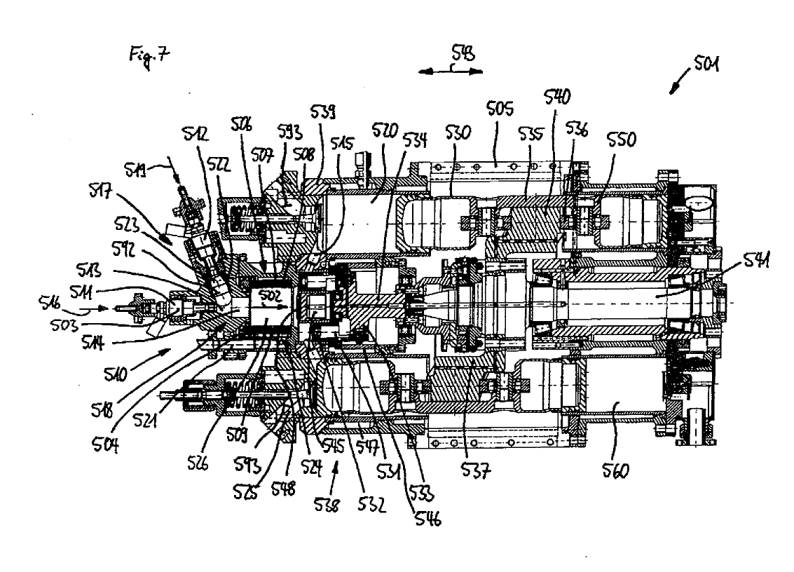

FIG. 5 a schematic top view of another axial-piston engine, in a depiction similar to that in FIG. 4, which can also be advantageously equipped with the assemblies shown in FIGS. 1 and 2;

FIG. 6 a schematic sectional view of an axial-piston engine with a combustion agent reservoir, on which the assemblies of FIGS. 1 and 2 can also be advantageously used;

FIG. 7 a schematic side view of a further axial-piston engine, on which the assemblies of FIGS. 1 and 2 can also be advantageously used;

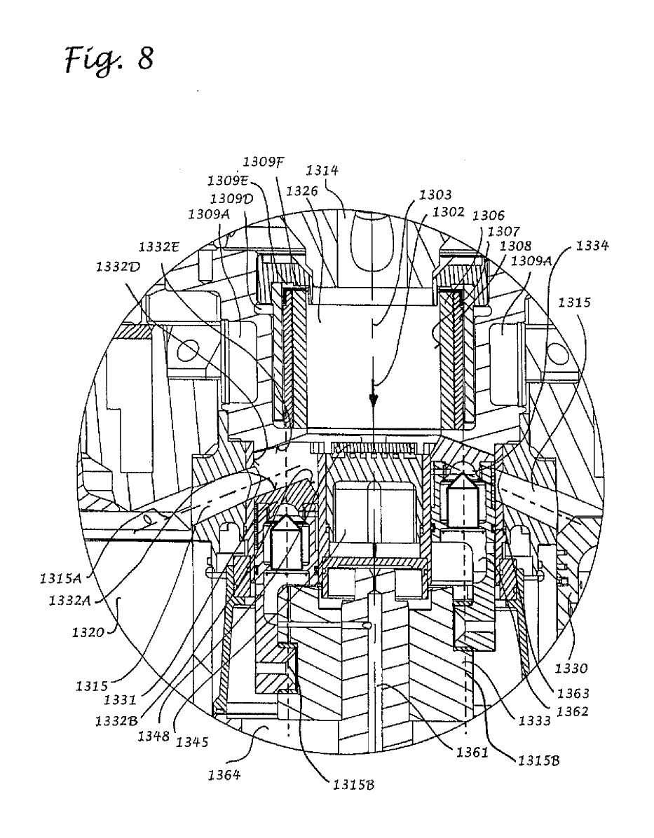

FIG. 8 a schematic sectional view of a further axial-piston engine with a control chamber formed as a pressure space, a cutaway view of the oil circuit and an alternative configuration of the control pistons;

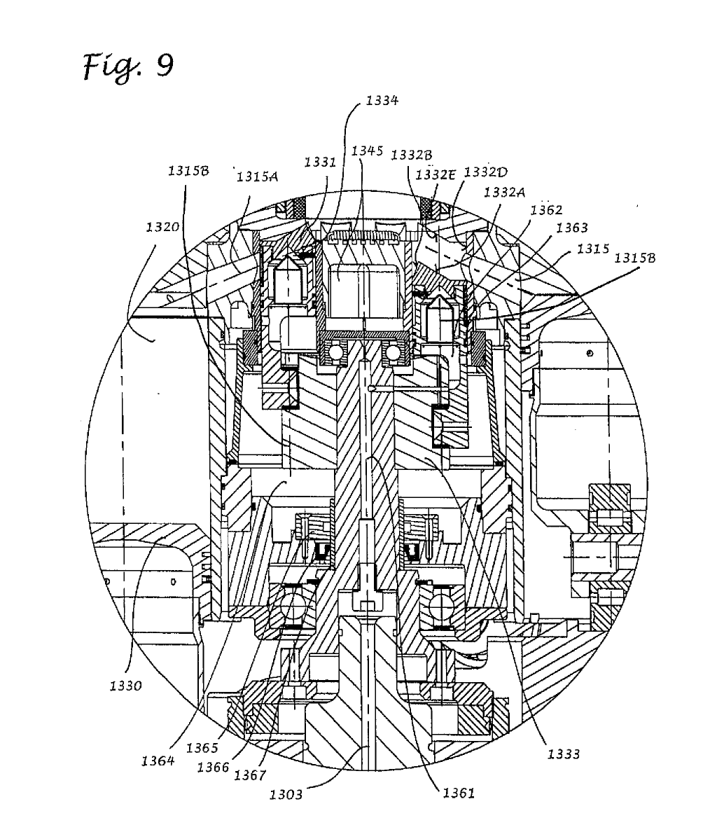

FIG. 9 a schematic sectional view of a further axial-piston engine with a control chamber formed as a pressure space, a cutaway view of the oil circuit and an alternative configuration of the control pistons;

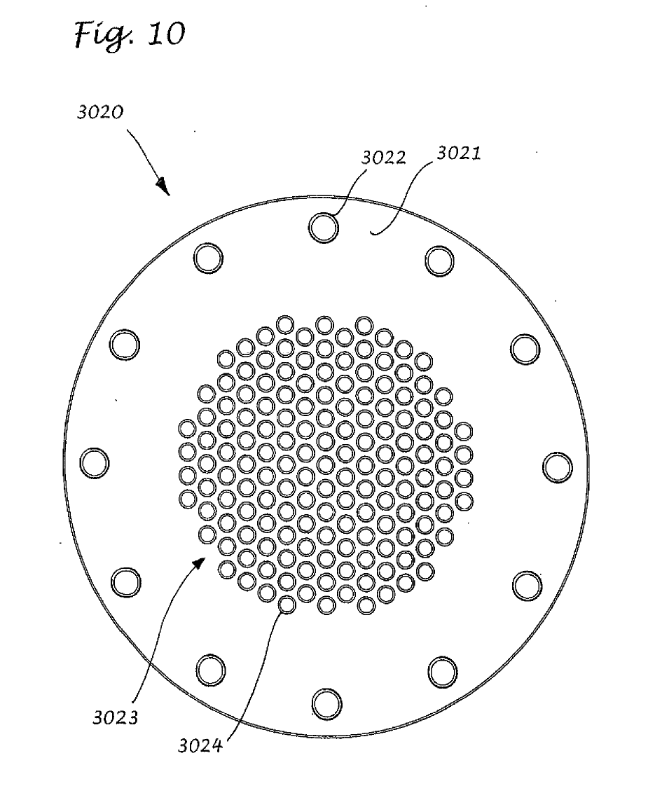

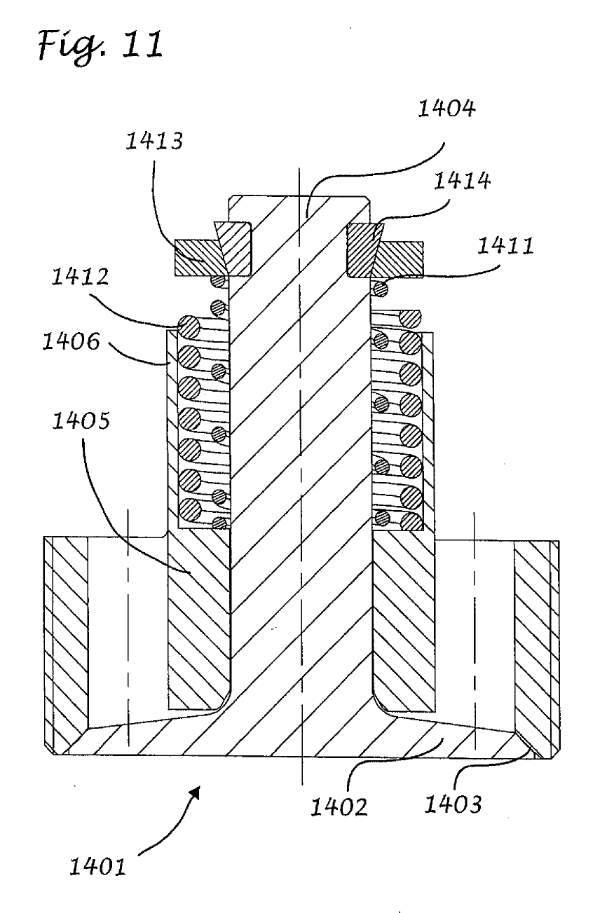

FIG. 10 a schematic view of a flange for a heat exchanger, with a matrix situated in it for accommodation of pipes of a heat exchanger;

FIG. 11 a schematic sectional view of a gas exchange valve with a valve spring and an impact spring; and

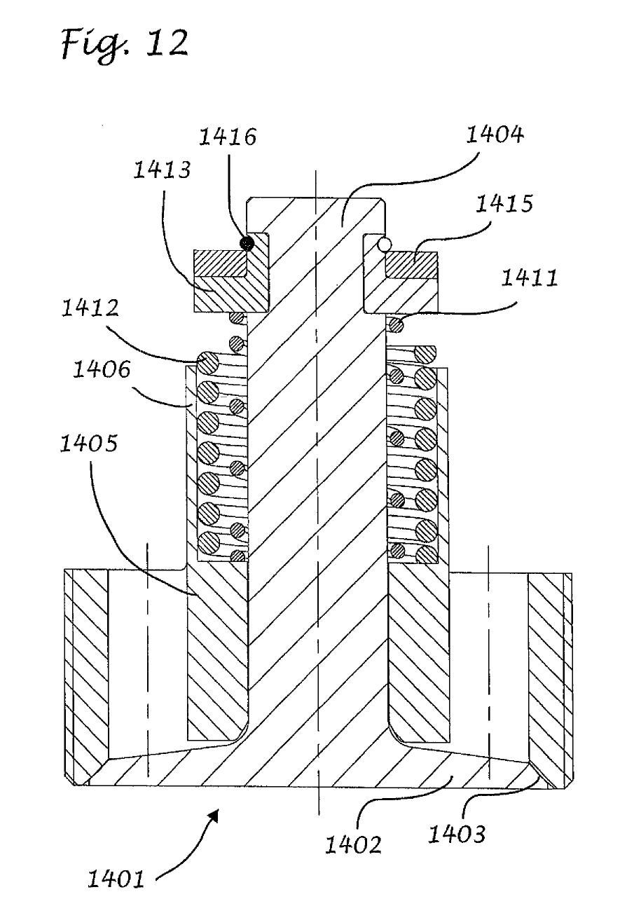

FIG. 12 a further schematic sectional view of a gas exchange valve with a valve spring and an impact spring.

In the detail view of the compressor side of an axial-piston engine 1101 depicted in FIG. 1, essentially a cylinder head 1151 of a compressor cylinder 1160 of the axial-piston engine 1101 is illustrated.

A compressor cylinder inlet valve 1152 and a plurality of compressor cylinder outlet valves 1153 (numbered merely as an example) are fitted into the cylinder head 1151. According to the invention, the compressor cylinder inlet valve 1152 is equipped with a ring-shaped inlet valve cover 1154, which is placed with a three-point holder 1158 (see FIG. 2) on the cylinder head 1151.

The ring-shaped inlet valve cover 1154 is pulled by in total three spiral springs 1159 (numbered only as an example here) against an inlet valve seat 1161, whereby openings 1162 (numbered only as an example here) of the compressor cylinder inlet valve 1152 corresponding to these, situated in the form of a ring, can be tightly closed.

As is to be further seen clearly from the detail view according to FIG. 1, the spiral springs 1159 are fastened at one end to the ring-shaped inlet valve cover 1154 and at the other end to holding arms 1163 of the three-point holder 1158 and are therefore biased in tension.

In a region 1164 inside the ring formed by the inlet valve cover 1154 in this exemplary embodiment, a water inlet 1165 is situated, by means of which water or water vapor can be applied into the compressor cylinder 1160. This takes place, for example, during an intake stroke, in which a compressor piston (not depicted here) moves away from the cylinder head 1151 and combustion air flows in via the openings 1162 of the opened compressor cylinder inlet valve 1152 into the compressor cylinder 1160.

By the fact that the openings 1162 are situated concentrically around the water inlet 1165, the water or the water vapor can be intermixed particularly rapidly, uniformly and intimately, during the intake stroke, with the combustion air flowing through the openings 1162, whereby a particularly homogeneous combustion agent comprising a mixture of combustion air and water is present in the compressor cylinder 1160, which can be compressed isothermally and not adiabatically as well as possible during compression. Hereby the efficiency of the axial-piston engine 1101 is also advantageously increased. In this case the combustion air passes via an appropriate supply line 1157 alongside the spiral springs 1159 to the openings 1162.

In the immediate vicinity of the compressor cylinder inlet valve 1152 there are compressor cylinder outlet valves 1153 (numbered only as an example here), via which the combustion agent compressed inside the compressor cylinder 1160 can be removed from the compressor cylinder 1160.

By the fact that the compressor cylinder outlet valves are of relatively small configuration, in particular smaller than the compressor cylinder inlet valve 1152, the compressor cylinder outlet valves 1153 are characterized by extremely short reaction times, whereby particularly rapid removal of combustion agent from the compressor cylinder 1160 is guaranteed.

Each of the compressor cylinder outlet valves 1153 in this exemplary embodiment has an outlet valve cover 1166, which is configured as a hemisphere 1167 and is pressed against a correspondingly shaped outlet valve seat 1168. To this end, each of the compressor cylinder outlet valves 1153 includes a compression spring 1169, which presses the outlet valve cover 1166 with its hemisphere 1167 against the outlet valve seat 1168.

Because of the fact that the outlet valve cover 1166 is configured as a hemisphere 1167, the outlet valve cover 1166 always seals the compressor cylinder outlet valve 1153 against the corresponding outlet valve seat 1168. Hereby even inaccuracies of the guide of the outlet valve cover 1166 and/or manufacturing tolerances of the outlet valve cover 1166 or of the outlet valve seat 1168 can be excellently compensated, so that the compressor cylinder outlet valve 1153 can always seal well. Even wear phenomena can be compensated well with the hemisphere 1167 of the outlet valve cover 1166, so that the compressor cylinder outlet valve 1153 additionally requires very little maintenance.

In order to be able to guarantee particularly good running smoothness and speed of the outlet valve cover 1166, the compressor cylinder outlet valve 1153 also includes means for alignment of the outlet valve cover 1166, which interact with the compression spring 1169, so that a particularly reliable guide for the outlet valve cover 1166 is guaranteed. This is the case even if the outlet valve cover 1166 were to have an asymmetric geometry relative to the working direction 1179.

The means for alignment of the outlet valve cover 1166 in this exemplary embodiment are realized as a guide bush 1189, into which the compression spring 1169 is inserted. The flat bearing face of the hemisphere 1167 also serves for corresponding alignment, since the compression spring 1169 has a corresponding aligning effect directly on this bearing face.

If the outlet valve cover 1166 is additionally configured to be at least partly hollow, the outlet valve cover 1166 can be constructed with particularly light weight, whereby the masses of the compressor cylinder outlet valve 1153 to be moved can be further reduced. As a result of this, the reaction times of the compressor cylinder outlet valve 1153 can be further advantageously shortened.

Some axial-piston engines onto which the compressor cylinder inlet valves and compressor cylinder outlet valves can be advantageously built will be described as examples in the following.

The axial-piston engine 201 depicted as an example in FIGS. 3 and 4 has a continuously working combustion chamber 210, from which working medium is fed successively via shot channels 215 (numbered as an example) to working cylinders 220 (numbered as an example). Situated in each of the working cylinders 220 are respective working pistons 230 (numbered as an example), which are connected on the one hand by way of a straight connecting rod 235 to an output, which is realized in this exemplary embodiment as a spacer 242 carrying a curved track 240, situated on an output shaft 241, and are connected on the other hand to a compressor piston 250, each of which runs in the compressor cylinder 260 in a manner explained in greater detail below.

After the working medium has performed its work in working cylinder 220 and has placed a load on working piston 230 accordingly, the working medium is expelled from the working cylinder 220 through exhaust gas channels 225. Provided on the exhaust gas channels 225 are temperature sensors, not shown, which measure the temperature of the exhaust gas.

The exhaust gas channels 225 discharge in each instance into heat exchangers 270, and subsequently leave the axial-piston engine 201 at appropriate outlets 227 in a known manner. The outlets 227 for their part can be connected again in particular to a ring channel, not shown, so that in the end the exhaust gas leaves the engine 201 at only one or two places. Depending on the concrete configuration in particular of the heat exchanger 270, a sound damper can possibly also be dispensed with, since the heat exchangers 270 themselves already have a sound-damping effect.

The heat exchangers 270 serve to preheat combustion agent which is compressed in the compressor cylinders 260 by the compressor pistons 250 and conducted through a pressure line 255 to the combustion chamber 210. The compression takes place in this case in a known manner, by the fact that supply air is drawn in through supply lines 257 (numbered as an example) by the compressor pistons 250 and compressed in the compressor cylinders 260. Known and readily appropriately utilizable valve systems are used to this end. Likewise the valve system described above can be used.

As immediately obvious from FIG. 4, the axial-piston engine 201 has two heat exchangers 270, each of which is situated axially in reference to the axial-piston engine 201. Through this arrangement, the paths which the exhaust gas must traverse through the exhaust gas channels 225, in each instance to the heat exchangers 270 can be reduced significantly, compared to state-of-the-art axial-piston engines. The result of this is that in the end the exhaust gas reaches the respective heat exchanger 270 at a significantly higher temperature, so that in the end the combustion agent can also be preheated to correspondingly higher temperatures. In practice, it has been found that at least 20% of fuel can be saved through such a configuration. It is assumed in this connection that even savings of up to 30% or more are possible by means of an optimized design.

Furthermore, the heat exchangers are insulated with a thermal insulation of asbestos substitute, not shown here. This ensures that with this exemplary embodiment the external temperature of the axial-piston engine does not exceed 450° C. in the vicinity of the heat exchanger 270 under nearly all operating conditions. The only exceptions are overload situations, which occur only briefly anyway. In this case, the thermal insulation is designed to ensure a temperature gradient of 350° C. at the hottest place of the heat exchanger.

In this connection it is understood that the efficiency of the axial-piston engine 201 can be increased through additional measures. For example, the combustion agent can be used in a known manner for cooling or thermally insulating the combustion chamber 210, whereby its temperature can be increased still further before it enters the combustion chamber 210. Let it be emphasized here that the corresponding tempering can be limited on the one hand only to components of the combustion agent, but tempering can also be carried out cumulatively or alternatively with water, which if necessary can also be applied at a suitable place of the combustion chamber 210. It is also conceivable to apply water to the combustion air already before or during the compression; this is also readily possible afterwards, however, for example in the pressure line 255.

Especially preferably, the application of water to the compressor cylinder 260 takes place during an intake stroke of the corresponding compressor piston 250, which results in isothermal compression, or compression as close as possible to isothermal compression. As is directly apparent, each working cycle of the compressor piston 250 comprises an intake stroke and a compression stroke, wherein during the intake stroke combustion agent enters the compressor cylinder 260, which is then compressed, i.e., compressed, during the compression stroke, and conveyed into the pressure line 255. By application of water during the intake stroke, a uniform distribution of the water can be ensured in an operationally simple manner.

It is likewise conceivable already to temper the fuel accordingly, wherein this is not absolutely necessary, since the quantity of fuel is usually relatively small in relation to the combustion air, and thus can be brought to high temperatures very quickly.

Likewise the application of water into the pressure line 255 can take place in this configuration, wherein inside the heat exchanger the water is mixed uniformly with the combustion agent by appropriate deflection of the flow. The exhaust gas channel 225 can also be selected for the application of water or another fluid, such as fuel or means for exhaust gas post-treatment, in order to guarantee homogeneous intermixing inside the heat exchanger 270. The configuration of the shown heat exchanger 270 further permits the post-treatment of the exhaust gas in the heat exchanger itself, wherein heat released by the post-treatment is supplied directly to the combustion agent present in the pressure line 255. A water trap, not depicted, which returns the condensed water present in the exhaust gas to the axial-piston engine 201 for renewed application, is situated in the outlet 227. The water trap can be designed in connection with a condenser. Furthermore, the use is possible in similarly designed axial-piston engines, wherein the other advantageous features on the axial-piston engine 201 or on similar axial-piston engines are advantageous even without use of a water trap in the outlet 227.

The axial-piston engine 301 depicted in FIG. 5 corresponds in its construction and in its manner of functioning essentially to the axial-piston engine 201 according to FIGS. 3 and 4. For this reason we will dispense with a detailed description, wherein assemblies in FIG. 5 that work similarly are also provided with similar reference labels and differ from one another only in the first digit. The axial-piston engine 301 also has a central combustion chamber 310, from which working medium in the working cylinder 320 can be conducted via shot channels 315 (numbered as an example) according to the working sequence of the axial-piston engine 301. After the working medium has performed its work, it is fed via exhaust gas channels 325 to heat exchangers 370, in each instance.

In this case the axial-piston engine 301, in contrast to the axial-piston engine 201, has one heat exchanger 370 each for exactly two working cylinders 320, whereby the length of the channels 325 can be reduced to a minimum. As is directly apparent, in this exemplary embodiment the heat exchangers 370 are partially inserted into the housing body 305 of the axial-piston engine 301, which leads to an even more compact construction than the construction of the axial-piston engine 201 according to FIGS. 3 and 4. In this case, the measure of how far the heat exchangers 370 can be inserted into the housing body 305 is limited by the possibility of the arrangement of other assemblies, such as, for example, a water cooling system for the working cylinders 220.

The axial-piston engine 401 depicted in FIG. 6 also corresponds essentially to the axial-piston engines 201 and 301 according to FIGS. 3 through 5. Accordingly, identically or similarly working assemblies are also labeled similarly, and differ only in the first digit. Accordingly, in other respects a detailed explanation of the mode of operation will also be dispensed with for this exemplary embodiment, since that was already done in reference to the axial-piston engine 201 according to FIGS. 3 and 4.

The axial-piston engine 401 also includes a housing body 405, on which a continuously working combustion chamber 410, six working cylinders 420 and six compressor cylinders 460 are provided. In this case the combustion chamber 410 is connected via shot channels 415 to the working cylinders 420, in each instance, so that working medium can be fed to the working cylinders 420 corresponding to the timing rate of the axial-piston engine 401.

After its work is done, the working medium leaves the working cylinders 420 through exhaust gas channels 425, which lead to heat exchangers 470, in each instance, wherein these heat exchangers 470 in the exemplary embodiment are arranged identically to the heat exchangers 270 of the axial-piston engine 201 according to FIGS. 3 and 4. It is understood that other arrangements of the heat exchangers 470 can also be provided in alternative embodiments. The working medium leaves the heat exchangers 470 through outlets 427 (numbered as an example).

Situated in the working cylinders 420 and the compressor cylinders 460 are working pistons 430 and compressor pistons 450, respectively, which are connected with one another by means of a rigid connecting rod 435. The connecting rod 435 includes in a known manner a curved track 440, which is provided on a spacer 424, which ultimately drives an output shaft 441.

In this exemplary embodiment also, combustion air is drawn in through supply lines 457 and compressed in the compressor cylinders 460, in order to be applied via pressure lines 455 to the combustion chamber 410, wherein the measures named in the case of the aforementioned exemplary embodiments can likewise be provided, depending on the concrete implementation.

In addition, in the case of the axial-piston engine 401 the pressure lines 455 are connected with one another via a ring channel 456, whereby a uniform pressure in all pressure lines 455 can be guaranteed in a known manner. Between the ring channel 456 and each of the pressure lines 455 valves 485 are provided, whereby the supply of combustion agent can be regulated or set by the pressure lines 455. Furthermore, a combustion agent reservoir 480 is connected to the ring channel 456 via a reservoir line 481, in which a valve 482 is likewise situated.

The valves 482 and 485 can be opened or closed, depending on the operating state of the axial-piston engine 401. Thus it is conceivable, for example, to close one of the valves 485 when the axial-piston engine 401 needs less combustion agent. It is also conceivable to partially close all valves 485 in such operating situations, and to allow them to operate as throttles. The surplus of combustion agent can then be fed to the combustion agent reservoir 480 when valve 482 is open. The latter is also possible in particular when the axial-piston engine 401 is running under deceleration, i.e., when no combustion agent at all is needed, but rather it is being driven via the output shaft 441. The surplus of combustion agent caused by the movement of the compressor pistons 450 that occurs in such an operating situation can likewise readily be stored in the combustion agent reservoir 480.

The combustion agent stored in this way can be fed supplementally to the axial-piston engine 401 as needed, i.e., in particular in driving off or acceleration situations, as well as for starting, so that a surplus of combustion agent is provided without additional or more rapid movements of the compressor pistons 450.

The valves 482 and 485 can also be dispensed with, if appropriate, to guarantee the latter. Foregoing such valves for prolonged storage of compressed combustion agent seems little suited, due to unavoidable leakage.

In an alternative embodiment to the axial-piston engine 401, the ring channel 456 can be dispensed with, wherein the outlets of the compressor cylinders 460 are then combined corresponding to the number of pressure lines 455—possibly by means of a section of ring channel. With a design of this sort it may possibly make sense to connect only one of the pressure lines 455, or not all pressure lines 455 to the combustion agent reservoir 480, or to not provide them as connectable. Such a configuration indeed means that not all compressor pistons 450 can fill the combustion agent reservoir 480 during deceleration. On the other hand, sufficient combustion agent is then available to the combustion chamber 410 so that combustion can be maintained without additional regulation or control system measures. Simultaneously with this, the combustion agent reservoir 480 is filled by means of the other compressor pistons 450, so that combustion agent is stockpiled accordingly and is available immediately, in particular for starting, driving off or acceleration phases.

It is understood that the axial-piston engine 401, in a different alternative embodiment not shown explicitly here, can be equipped with two combustion agent reservoirs 480, wherein the two combustion agent reservoirs 480 can then also be charged with different pressures, so that it is always possible with the two combustion agent reservoirs 480 to work with different pressure intervals in real time. Preferably a pressure regulating system is provided in this case, which sets a first lower pressure limit and a first upper pressure limit for the first combustion agent reservoir 480, and a second lower pressure limit and a second upper pressure limit for the second combustion agent reservoir (not shown here), inside which a combustion agent reservoir 480 is charged with pressures, wherein the first upper pressure limit is below the second upper pressure limit and the first lower pressure limit is below the second lower pressure limit. Specifically, the first upper pressure limit can be set lower than or equal to the second lower pressure limit.

In the axial-piston engines 201, 301, 401 according to FIGS. 3 through 6, temperature sensors for measuring the temperature of the exhaust gas or in the combustion chamber are not depicted. For such temperature sensors, all temperature sensors can be considered which can operationally reliably measure temperatures between 800° C. and 1,100° C. In particular, if the combustion chamber comprises a precombustion chamber and a main combustion chamber, the temperature of the precombustion chamber can also be measured by means of such temperature sensors. In this respect, the axial-piston engines 201, 301 and 401 described above can each be regulated by means of the temperature sensors in such a way that the exhaust gas temperature when leaving the working cylinders 220, 320, 420 is approximately 900° C., and the temperature in the precombustion chamber—if present—is approximately 1,000° C.

In the case of the other axial-piston engine 501 shown as an example according to the depiction in FIG. 7, such temperature sensors are present in the form for example of a prechamber temperature sensor 592 and two exhaust gas temperature sensors 593, and are depicted schematically accordingly. In particular by means of the prechamber temperature sensor 592—which in this exemplary embodiment can also be referred to as preburner temperature sensor 592, due to its proximity to a preburner 517 of the other axial-piston engine 501—a meaningful value concerning the quality of combustion or with regard to the running stability of the other axial-piston engine 501 is ascertained. For example, a flame temperature can be measured in the preburner 517, in order to be able, to regulate different operating states in the other axial-piston engine 501 by means of a combustion chamber regulating system. By means of the exhaust gas temperature sensors 593, which are positioned at outlets or exhaust gas channels 525 of the respective working cylinder 520, specifically the operating state of the combustion chamber 510 can be checked cumulatively and regulated if necessary, so that optimal combustion of the combustion agents is always ensured.

Otherwise, the construction and operating principle of the other axial-piston engine 501 correspond essentially to those of the previously described axial-piston engines. In this respect, the other axial-piston engine 501 has a housing body 505, on which a continuously working combustion chamber 510, six working cylinders 520 and six compressor cylinders 560 are provided.

Inside the combustion chamber 510, combustion agent can be both ignited and burned, wherein the combustion chamber 510 can be charged with combustion agents in the manner described above. Advantageously, the other axial-piston engine 501 works with a two-stage combustion system, to which end the combustion chamber 510 has the previously already mentioned preburner 517 and a main burner 518. Combustion agents can be injected into the preburner 517 and into the main burner 518, wherein a proportion of a combustion air of the axial-piston engine 501, which specifically in this exemplary embodiment can be less than 15% of the total combustion air, can be introduced in particular into the preburner 517.

The preburner 517 has a smaller diameter than the main burner 518, wherein the combustion chamber 510 has a transition area that comprises a conical chamber 513 and a cylindrical chamber 514.

To supply combustion agent or combustion air, on the one hand a main nozzle 511 and on the other hand a processing nozzle 512 discharge into the combustion chamber 510, in particular into the associated conical chamber 513. By means of the main nozzle 511 and the processing nozzle 512, combustion agents or combustible substance can be injected into the combustion chambers 510.

The main nozzle 511 is aligned essentially parallel to a main combustion direction 502 of the combustion chamber 510. Furthermore, the main nozzle 511 is aligned coaxially to an axis of symmetry 503 of the combustion chamber 510, wherein the axis of symmetry 503 lies parallel to the main combustion direction 502.

Furthermore, the processing nozzle 512 is situated at an angle (not sketched explicitly here for the sake of clarity) with respect to the main nozzle 511, so that a jet direction 516 of the main nozzle 511 and a jet direction 519 of the processing nozzle 512 intersect at a mutual point of intersection within the conical chamber 513.

Combustible substance or fuel is injected from the main nozzle 511 into the main burner 518 in this exemplary embodiment without additional air supply, wherein the combustible substance can already be preheated and ideally thermally decomposed by the preburner 517. To this end, the volume of combustion air corresponding to the quantity of combustible substance flowing through the main nozzle 511 is introduced into a combustion space 526 behind the preburner 517 or the main burner 518, to which end a separate combustion air supply system 504 is provided, which discharges into the combustion space 526.

To this end, the separate precombustion air supply system 504 is connected to a process air supply 521, wherein a further combustion air supply system 522 can be supplied with combustion air from the separate combustion air supply 504, which in this case supplies a perforated ring 523 of the preburner 517 with combustion air. The perforated ring 523 is assigned in this case to the processing nozzle 512. In this respect, the combustible substance injected with the processing jet 512, mixed additionally with process air, can be injected into the conical chamber 513 of the main burner 518.

In addition, the combustion chamber 510, in particular the combustion space 526, includes a ceramic assembly 506, which is advantageously air-cooled. Water cooling or cooling with a combination of combustion air and water can also be provided. The ceramic assembly 506 includes in this case a ceramic combustion chamber wall 507, which in turn is surrounded by a profiled pipe 508. Around this profiled pipe 508 extends a cooling air chamber 509, which is connected to the process air supply system 521 by means of a cooling air chamber supply system 524.

The known working cylinders 520 carry corresponding working pistons 530, which are mechanically connected to compressor pistons 550 by means of connecting rods 535, in each instance.

In this exemplary embodiment the connecting rods 535 include connecting rod running wheels 536, which run along a curved track 540, while the working pistons 530 or the compressor pistons 550 are moved. An output shaft 541 is thereby set in rotation, which is connected to the curved track 540 by means of a driving curved track carrier 537. Power produced by the axial-piston engine 501 can be delivered via the output shaft 541.

In a known way, by means of the compressor pistons 550, compression of the process air occurs, also including injected water if appropriate, as already described above. If the application of water or of water vapor occurs during an intake stroke of the corresponding compressor piston 550, compression of the combustion agent as close as possible to isothermal can specifically be promoted. An application of water that accompanies the intake stroke can ensure an especially uniform distribution of the water within the combustion agent, in an operationally simple manner.

Exhaust gases can be cooled significantly more deeply thereby, if necessary, in one or more heat exchangers not depicted here, if the process air is to be prewarmed by means of one or more such heat exchangers and carried to the combustion chamber 510 as combustion agent, as described for example already in detail in the exemplary embodiments already explained above with regard to FIGS. 3 through 6 in particular. The exhaust gases can be fed to the heat exchanger or heat exchangers via the exhaust gas channels 525 named above, wherein the heat exchangers are arranged axially in reference to the other axial-piston engine 501.

Corresponding to the axial-piston engine 201, heat exchanger insulating systems can also be provided in the axial-piston engine 501, and otherwise also in the axial-piston engines 301 and 401.

In addition, the process air can be further prewarmed or heated through a contact with additional assemblies of the axial-piston engine 501 that must be cooled, as has also already been explained. The process air compressed and heated in this way is then applied to the combustion chamber 510 in the manner that has already been explained, whereby the efficiency of the other axial-piston engine 501 can be further increased.

Each of the working cylinders 520 of the axial-piston engine 501 is connected via a shut channel 515 to the combustion chamber 510, so that an ignited mixture of combustion agent and combustion air can pass out of the combustion chamber 510 via the shot channels 515 into the respective working cylinder 520 and can perform work on the working pistons 530 as a working medium.

In this respect, the working medium flowing from the combustion chamber 510 can be fed via at least one shot channel 515 successively to at least two working cylinders 520, wherein for each working cylinder 520 one shot channel 515 is provided, which can be closed and opened by means of a control piston 531. Likewise a plurality of shot channels can also be provided for each working cylinder. Thus the number of the control pistons 531 of the other axial-piston engine 501 is predetermined by the number of the working cylinders 520 and by the number of shot channels per working cylinder 520. Closing of the shot channel 515 is done in this case by means of the control piston 531, including its control piston cover 532. The control piston 531 is driven by means of a control piston curved track 533, wherein a spacer 534 for the control piston curved track 533 to the drive shaft 541 is provided, which also serves in particular for thermal decoupling. In the present exemplary embodiment of the other axial-piston engine 501, the control piston 531 can perform an essentially axially directed stroke motion 543. To this end, each of the control pistons 531 is guided by means of sliders, not further labeled, which are supported in the control piston curved track 533, wherein the sliders each have a safety cam that runs back and forth in a guideway, not further labeled, and prevents turning of the control piston 531.

Since the control piston 531 comes into contact in the area of the shot channel 515 with the hot working medium from the combustion chamber 510, it is advantageous if the control piston 531 is water-cooled. To this end, the other axial-piston engine 501 has a water cooling system 538, in particular in the area of the control piston 531, wherein the water cooling system 538 includes inner cooling channels 545, middle cooling channels 546 and outer cooling channels 547. Well cooled in this way, the control piston 531 can be moved operationally reliably in a corresponding control piston cylinder.

Furthermore, the surfaces of the control piston 531 in contact with combustion agent are reflective or provided with a reflective coating, so that heat input occurring via heat radiation into the control pistons 531 is minimized. The further surfaces of the shot channels 515 and of the combustion chamber 510 in contact with combustion agent are also provided in this exemplary embodiment (likewise not depicted) with a coating having high spectral reflectivity. This is true in particular for the combustion chamber floor (not explicitly numbered), but also for the ceramic combustion chamber wall 507. It is understood that this configuration of the surfaces in contact with combustion agent can be present in an axial-piston engine even independently of the other configuration features. It is understood that, in modified embodiments, further assemblies can also be reflective or else the aforementioned reflectivenesses can be omitted at least partly.

The shot channels 515 and the control pistons 531 can be provided using especially simple construction, if the other axial piston engine 501 has a shot channel ring 539. In this case the shot channel ring 539 has a middle axis, around which in particular the parts of the working cylinders 520 and of the control piston cylinders are arranged concentrically. Between each working cylinder 520 and control piston cylinder a shot channel 515 is provided, wherein every shot channel 515 is spatially connected to a cutout (not labeled here) of a combustion chamber floor 548 of the combustion chamber 510. In this respect, the working medium can pass from the combustion chamber 510 via the shot channels 515 into the working cylinders 520 and there perform work, by means of which the compressor pistons 550 can also be moved. It is understood, that coatings and inserts can also be provided, depending on the concrete configuration, in order to protect in particular the shot channel ring 539 or its material from direct contact with corrosive combustion products or with excessively high temperatures. The combustion chamber floor 548 in turn can also be provided on its surface with a further ceramic or metallic coating, especially a reflective coating, which on the one hand reduces the heat radiation emerging from the combustion chamber 510 by increasing the reflectivity and on the other hand reduces the heat conduction by reducing the thermal conductivity.

The other axial-piston engine 501 can likewise be equipped with at least one combustion agent reservoir and corresponding valves, although this is not shown explicitly in the concrete exemplary embodiment according to FIG. 6. In addition, in the case of the other axial-piston engine 501, the combustion agent reservoir can be provided in a multiple version, in order to be able to store compressed combustion agents at different pressures.

The combustion agent reservoirs can be connected in this case to corresponding pressure lines of the combustion chamber 510, wherein the combustion agent reservoirs are fluid-connectable with or separable from the pressure lines by means of valves. Stop valves or throttle valves, or regulating or control valves, can be provided in particular between the working cylinders 520 or compressor cylinders 560 and the combustion agent reservoir. For example, the aforementioned valves can be opened or closed appropriately during driving-off or acceleration situations, as well as for starting, whereby a surplus of combustion agent can be made available to the combustion chamber 510, at least for a limited period of time. The combustion agent reservoirs are interconnected fluidically preferably between one of the compressor cylinders and one of the heat exchangers.

The two combustion agent reservoirs are ideally operated at different pressures, in order thereby to be able to make very good use of the energy provided by the other axial-piston engine 501 in the form of pressure. To this end, the provided upper pressure limit and lower pressure limit at the first combustion agent reservoir can be set by means of an appropriate pressure regulating system below the upper pressure limits and lower pressure limits of the second combustion agent reservoir. It is understood that in this case work can be done on the combustion agent reservoirs with different pressure intervals.

The further axial-piston engines depicted in FIGS. 8 and 9 correspond substantially to the axial-piston engine 501, so that in this respect a new explanation of the modes of action and operation is not needed. A substantial difference between the axial-piston engines from FIGS. 8 and 9 on the one hand and the axial-piston engine 501 on the other hand is the cooling of the combustion space 1326 charged with combustion agent via the cylindrical camber 1314, which in the depicted axial-piston engines takes place supplementally via water. It is understood that water cooling of this or similar sort can also be provided in the axial-piston engine 501 or the other axial-piston engines depicted here. To this end, each of the two axial-piston engines has a water chamber 1309A, which surrounds the combustion space 1326 and is fed with liquid water via a supply line. To this end, water with combustion chamber pressure is supplied in each instance via the supply line, not numbered.

This water is applied via branch channels in each instance to a ring channel 1309B, which is in contact with a steel pipe (not numbered), which for its part surrounds the profiled pipe 1308 of the respective combustion space 1326 and is dimensioned such that a ring gap (not numbered) remains in each instance both between the profiled pipe 1308 and the steel pipe on the one hand and also between the steel pipe and the housing part containing the branch channels on the other hand, and such that the two ring gaps are connected with one another via the end of the steel pipe facing away from the ring channel 1309D. It is understood in this case that the pipes can also be made of a material other than steel.

In the depicted axial-piston engines, further ring channels 1309E, which on the one hand are connected with the respective radially inward ring gap and on the other hand open via channels 1309F into a ring nozzle (not numbered), which leads into the respective combustion space 1326, are provided above the profiled pipes 1308. In this case the ring nozzle is aligned axially relative to the combustion chamber wall or to the ceramic combustion chamber wall 1307, so that the water can protect the ceramic combustion chamber wall 1307 even on the combustion chamber side.

It is understood that the water can vaporize in each instance on its way from the supply line to the combustion space 1326 and that the water can be provided if necessary with further additives. It is also understood that if necessary the water can be recovered from the exhaust gas of the respective axial-piston engine and reused.

The axial-piston engine otherwise corresponding substantially to the exemplary embodiments described above includes a combustion space 1326, control pistons 1331, shot channels 1315 and working pistons 1330. The combustion space 1326 situated with rotational symmetry around the axis of symmetry 1303 has, as described above, a ceramic assembly 1306 with a ceramic combustion chamber wall 1307 and a profiled steel pipe 1308. The main combustion direction 1302, in which combustion agent flows in the direction of the shot channels 1315 and working cylinders 1320, extends along the axis of symmetry 1303. The combustion space 1326 is separated from the working cylinder 1320 by the control pistons 1331, situated parallel to the axis of symmetry 1303. Because of the oscillating movement of the control pistons 1331 along their longitudinal axes 13153, a shot channel 1315 belonging to a control piston is periodically released in each instance, as soon as the working piston 1330 present in the working cylinder 1320 executes a movement in the direction of its top dead point or is already positioned at the top dead point. The shot channel 1315 has the axis of symmetry 1315A, along which a guide face 1332A is aligned. The guide face 1332A aligned parallel to this axis of symmetry 1315A is therefore flush with a wall of the shot channel 1315, as soon as the control piston 1331 is at its bottom dead point, and hereby permits deflection-tree flow of the combustion agent in the direction of the working cylinder 1320. In turn, a guide-face sealing face 1332E is aligned parallel to the guide face 1332A, so that this guide-face sealing face 1332E approximately closes upon the guide face 1332A, as soon as the control piston 1331 has reached its top dead point. The cylindrical jacket face of the control piston 1331 further closes upon a stem sealing face 1332D and thus reinforces the sealing action between the combustion space 1326 and the working cylinder 1320. In addition, the control piston 1331 has an impact face 1332B, which is aligned approximately at right angles to the axis of symmetry of the shot channel 1315A. This alignment therefore takes place approximately normal relative to the flow direction of the combustion agent, when this emerges from the combustion space 1326 and enters the shot channel 1315. Consequently, this part of the control piston 1331 is loaded as little as possible by a heat flow, since the impact face 1332B has a minimum surface relative to the combustion space 1326.

The control piston 1331 is controlled via the control piston curved track 1333. This control piston curved track 1333 does not necessarily have a sinusoidally shaped profile. A control piston curved track 1333 deviating from sinusoidal shape makes it possible to hold the control piston 1331 for a specified time interval at the respective top or bottom dead point and hereby, on the one hand, to keep the opening cross section at its maximum possible while the shot channel 1315 is open and, on the other hand, to keep the thermal stress of the control piston surface as a consequence of a critical flow velocity of the combustion agent as low as possible during opening and closing of the shot channel, in that a maximum possible opening speed at the instant of opening is selected via the configuration of the control piston curved track 1333.

FIG. 8 also shows a control piston oil space 1362 present in the control piston 1331, which serves the control piston seal 1363 with oil or receives oil flowing back again from the control piston seal 1363. The control piston oil space 1362 is fed via the pressure-oil circuit 1361. The bottom side of the control piston 1331 points in the direction of the control chamber 1364, formed as the pressure space. At the same time, the control chamber 1364 collects oil emerging from the control piston 1331 and the pressure-oil circuit 1361. It is also possible optionally to charge the inner cooling channels 1345 with oil via the pressure-oil circuit 1361 instead of via a water circuit, in order to cool the bottom side of the combustion space 1326.

In the exemplary embodiment depicted in FIG. 9, a first control chamber seal 1365 and a second control chamber seal 1366 designed as a radial shaft seal ring are provided, which seal the control chamber 1364, which may be at higher pressure, relative to the rest of the axial-piston engine, which is under approximately environmental pressure. The first control chamber seal 1365 and second control chamber seal 1366 seal the control chamber 1364 via a sealing sleeve 1367. This sealing sleeve 1367 is seated by means of a press fit on a rotating central shaft of the axial-piston engine, which partly contains the pressure-oil circuit 1361. Of course, the sealing sleeve 1367 can also be connected with the rotating shaft in a different manner. A material connection or an additional seal between the shaft and the sealing sleeve 1367 is also conceivable. As is immediately obvious, these seals are seated on a relatively small radius, so that efficiency losses can be minimized. Likewise these seals are located in a relatively cool region of the axial-piston engine, so that conventional seals can be employed here.

FIG. 9 also shows a further configuration of the control-piston surfaces used for sealing the shot channels 1315. Therein it is evident that the impact face 1332B does not necessarily have to be a planar face, but can also be a segment of a spherical, cylindrical or conical surface and thus can have rotationally symmetric shape relative to the axis of symmetry 1303. The guide face 1332A and the guide-face sealing face 1332E can also have shape different from planar. In this case FIG. 9 shows a configuration of the guide face 1332A and of the guide-face sealing face 1332E, wherein these faces represent an angled line, at least in a sectional plane.

The surfaces of the control piston 1331 depicted in this embodiment, such as, for example, the guide face 1332A or the impact face 1332E, as well as the sealing faces, such as the guide-face sealing face 1332E or the stem sealing face 1332D, are also reflective, in order to suppress or minimize heat losses occurring via the control piston due to heat radiation. The applied reflective coating of these surfaces can furthermore also consist of a ceramic coating, which reduces the thermal conductivity or the heat transmission to the control piston. Just as the surfaces of the control piston 1331, the surface of the combustion chamber floor 1348 (shown as an example in FIG. 6) is reflective, in order to minimize heat loss in the wall. In addition, internal cooling channels, which remove heat from the combustion space 1326 optionally with water or oil, are situated on the bottom side of the combustion chamber floor 1348.

The cooling chamber 1334 of the control piston 1331 depicted in FIG. 9 is filled with a metal, sodium in this exemplary embodiment, present in liquid form at operating temperature of the axial-piston engine, which can remove heat from the surfaces of the control piston by convection and heat conduction and discharge it to the oil present in the pressure-oil circuit 1361.

FIG. 10 shows a heat exchanger head plate 3020 which is suitable for use for a heat exchanger for an axial-piston engine. For the purpose of mounting on and connection to an output manifold of an axial-piston engine, the heat exchanger head plate 3020 includes a flange 3021 with corresponding bore holes 3022 arranged in a circle of holes in the radially outer area of the heat exchanger head plate 3020. In the radially inner area of the flange 3021 is the matrix 3023, which has numerous bore holes designed as pipe seats 3024 for accommodation of pipes.

The entire heat exchanger head plate 3020 is preferably made from the same material from which the pipes are also made, in order to ensure that the thermal expansion coefficient is as homogeneous as possible in the entire heat exchanger and that thermal heat stresses in the heat exchanger are thereby minimized. Cumulatively to this, the jacket housing of the heat exchanger can likewise be produced from a material that corresponds to the heat exchanger head plate 3020 or to the pipes. The pipe seats 3024 can be designed for example with a fit such that the pipes mounted in these pipe seats 3024 are inserted by means of a press fit.

Alternatively to this, the pipe seats 3024 can also be designed so that a clearance fit or a transition fit is realized. In this way, mounting of the pipes in the pipe seats 3024 can also take place by means of a materially bonded connection rather than a frictional connection. The material connection is preferably effected in this case by welding or soldering, wherein a material corresponding to the heat exchanger head plate 3020 or to the pipes is used as the soldering or welding material. This also has the advantage that thermal stresses in the pipe seats 3024 can be minimized by homogeneous thermal expansion coefficients.

It is also possible in the case of this accomplishment to install pipes in the pipe seats 3024 by press fit, and in addition to solder or weld them. Through this type of installation, seal tightness of the heat exchanger can be ensured even if different materials are used for the pipes and the heat exchanger head plate 3020, since the possibility exists that due to the very high occurring temperatures of over 1,000° C. use of only a press fit can fail under certain circumstances because of different thermal expansion coefficients.

FIG. 11 shows a schematic sectional view of a gas-exchange valve 1401 with a valve spring 1411 and an impact spring 1412. In this case the gas-exchange valve 1401 is designed as an automatically opening valve without cam control, which opens at a specified pressure difference, wherein the cylinder internal pressure during an intake process of the cylinder is lower than the pressure in the inlet channel, from which the corresponding cylinder draws a combustion agent. The gas-exchange valve 1401 is preferably used as an inlet valve in the compressor stage. In this case the valve spring 1411 makes a closing force available to the gas-exchange valve 1401, by means of which the opening time can be determined via the configuration of the valve spring 1411. The valve spring 1411, which engages around the valve stem 1404 of the gas-exchange valve 1401, is seated in this case in a valve guide 1405 and is braced against the valve spring plate 1413.

The valve spring plate 1413 in turn is fixed positively on the valve stem 1404 of the gas-exchange valve 1401 with at least two key pieces 1414.

The configuration of the valve spring 1411, wherein this valve spring 1411 is designed precisely such that opening of the gas-exchange valve 1401 already takes place at small pressure differences, can lead under certain operating conditions to the situation that the gas-exchange valve 1401 experiences such a high acceleration due to the pressure difference present at the valve plate 1402 that it leads to excessive opening of the gas-exchange valve 1401 beyond the defined valve stroke.

Upon opening of the gas-exchange valve 1402, the valve plate 1402 releases, at its valve seat 1403, a flow cross section that from a certain valve stroke on does not substantially increase further geometrically. The maximum flow cross section at the valve seat 1403 is usually defined via the diameter of the valve plate 1402. The stroke of the gas-exchange valve 1401 at maximum flow cross section corresponds approximately to one fourth of the diameter of the valve plate 1402 at its inner valve seat. Upon exceedance of the valve stroke or of the computed valve stroke at maximum flow cross section, on the one hand no further substantial increase of the air mass flow occurs at the flow cross section between the valve seat 1403 and the valve plate 1402, and on the other hand it is possible that the valve spring plate 1413 will come into contact with a fixed component of the cylinder head, for example the valve spring guide 1406 in this case, and thus that the valve spring plate 1413 or the valve spring guide 1406 will be destroyed.

In order to prevent or limit this excessive opening of the gas-exchange valve 1401, the valve spring plate 1403 comes up against the impact spring 1412, whereby the total spring force, consisting of the valve spring 1411 and the impact spring 1412, increases suddenly and the gas-exchange valve 1402 is subjected to strong deceleration. In this exemplary embodiment, the stiffness of the impact spring 1412 is chosen such that, at maximum opening speed of the gas-exchange valve 1401, the gas-exchange valve 1401 is retarded just strongly enough by coming up against the impact spring 1412 that no contact is established between moving components of the valve group, such as, for example, the valve spring plate 1413, and fixed components, such as, for example, the valve spring guide 1406.

The spring force applied in two stages in this embodiment further imparts the advantage that, during the closing process of the gas-exchange valve 1401, this gas-exchange valve 1401 is not accelerated excessively in the opposite direction and does not impact the valve seat 1403 with excessive speed in the valve plate 1402, since the valve spring 1411 responsible for opening and closing the gas-exchange valve 1401 is designed precisely such that it does not supply any excessively high spring forces.

FIG. 12 shows a further schematic sectional view of a gas-exchange valve 1401 with a valve spring 1411 and an impact spring 1412, in which a two-piece valve spring plate 1413 is used in combination with a bracing ring 1415. In this embodiment, the split valve spring plate 1413 is brought into contact with the valve stem 1404 without use of cone pieces 1414, and there it absorbs the spring forces of the valve spring 1411 and of the impact spring 1412 positively. In this case the bracing ring 1415 represents on the one hand a captive safeguard and on the other hand the bracing ring 1415 absorbs forces in radial direction as viewed from the axis of the valve stem. A retaining ring 1416 in turn secures the bracing ring 1415 against falling out.

In order further to achieve smooth opening and closing of the gas-exchange valve, gas-exchange valves 1401 according to this embodiment, i.e., for use in the compressor stage and as an automatically opening valve, are made from a light metal. The lower inertia of a gas-exchange valve 1402 of light metal favors the rapid opening but also the rapid and gentle closing of the gas-exchange valve 1401. Also, the valve seat 1403 is preserved by the low inertia, since the gas-exchange valve 1401 in this embodiment does not release any excessively high kinetic energies during settlement into the valve seat 1403. The gas-exchange valve 1401 shown is preferably made of dural, a high-strength aluminum alloy, whereby the gas-exchange valve 1401 has adequately high strength despite its low density.

Reference labels:

| | |
|---|---|
| 201 | axial piston engine |
| 205 | housing body |
| 210 | combustion chamber |
| 215 | shot channel |
| 220 | working cylinder |
| 225 | exhaust gas channel |
| 227 | outlet |
| 230 | working piston |
| 235 | connecting rod |
| 240 | curved track |
| 241 | output shaft |
| 242 | spacer |
| 250 | compressor piston |
| 255 | pressure line |
| 257 | supply line |
| 260 | compressor cylinder |
| 270 | heat exchanger |
| 301 | axial piston engine |
| 305 | housing body |
| 310 | combustion chamber |
| 315 | shot channel |
| 320 | working cylinder |
| 325 | exhaust gas channel |
| 370 | heat exchanger |
| 401 | axial piston engine |
| 405 | housing body |
| 410 | combustion chamber |
| 415 | shot channel |
| 420 | working cylinder |
| 425 | exhaust gas channel |
| 427 | outlet |
| 430 | working piston |
| 435 | connecting rod |
| 440 | curved track |
| 441 | output shaft |
| 442 | spacer |
| 450 | compressor piston |
| 455 | pressure line |
| 456 | ring channel |
| 457 | supply line |
| 460 | compressor cylinder |
| 470 | heat exchanger |
| 480 | combustion agent reservoir |
| 481 | reservoir line |
| 485 | valve |
| 501 | axial piston engine |
| 502 | main combustion direction |
| 503 | axis of symmetry |
| 504 | combustion air supply system |
| 505 | housing body |
| 506 | ceramic assembly |
| 507 | ceramic combustion chamber wall |
| 508 | profiled pipe |
| 509 | cooling air chamber |
| 510 | combustion chamber |
| 511 | main nozzle |
| 512 | processing nozzle |
| 513 | conical chamber |
| 514 | cylindrical chamber |
| 515 | shot channel |
| 516 | first jet direction |
| 517 | preburner |
| 518 | main burner |
| 519 | further jet direction |
| 520 | working cylinder |
| 521 | process air supply system |
| 522 | further combustion air supply system |
| 523 | perforated ring |
| 524 | cooling air chamber supply system |
| 525 | exhaust gas channel |
| 526 | combustion space |
| 530 | working piston |
| 531 | control piston |
| 532 | control piston cover |
| 533 | control piston curved track |
| 534 | spacer |
| 535 | connecting rod |
| 536 | connecting rod running wheels |
| 537 | driving curved track carrier |
| 538 | water cooling system |
| 539 | shot channel ring |
| 540 | curved track |
| 541 | output shaft |
| 543 | stroke motion |
| 545 | inner cooling channels |
| 546 | middle cooling channels |
| 547 | outer cooling channels |
| 548 | combustion chamber floor |
| 550 | compressor piston |
| 560 | compressor cylinder |
| 592 | prechamber temperature sensor |
| 593 | exhaust gas temperature sensor |
| 1302 | main combustion direction |
| 1101 | axial piston engine |
| 1151 | cylinder head |
| 1152 | compressor cylinder inlet valve |
| 1153 | compressor cylinder outlet valve |
| 1154 | ring-shaped inlet valve cover |
| 1157 | supply line |
| 1158 | three-point holder |
| 1159 | spiral spring |
| 1160 | compressor cylinder |
| 1161 | valve seat |
| 1162 | openings |
| 1163 | holding arms |
| 1164 | region |
| 1165 | water inlet |
| 1166 | outlet valve cover |
| 1167 | hemisphere |
| 1168 | outlet valve seat |
| 1169 | compression spring |
| 1179 | working direction |
| 1189 | guide bush |
| 1302 | main combustion direction |
| 1303 | axis of symmetry |
| 1306 | ceramic assembly |
| 1307 | ceramic combustion chamber wall |
| 1308 | profiled steel pipe |
| 1309A | water chamber |
| 1309D | ring channel |
| 1309E | ring channel |
| 1309F | channel |
| 1314 | cylindrical chamber |
| 1315 | shot channel |
| 1315A | axis of symmetry of the shot channel |
| 1315B | longitudinal axis of the control piston |
| 1320 | working cylinder |
| 1326 | combustion space |
| 1330 | working piston |
| 1331 | control piston |
| 1332A | guide face |
| 1332B | impact face |
| 1332D | stem sealing face |
| 1332E | guide-face sealing face |
| 1333 | control piston curved track |
| 1334 | cooling chamber |
| 1345 | inner cooling channels |
| 1348 | combustion chamber floor |
| 1361 | pressure-oil circuit |
| 1362 | control piston oil space |
| 1363 | control piston seal |
| 1364 | control chamber |
| 1365 | first control chamber seal |
| 1366 | second control chamber seal |
| 1367 | sealing sleeve |
| 1401 | gas exchange valve |
| 1402 | valve plate |
| 1403 | valve seat |
| 1404 | valve stem |
| 1405 | valve guide |
| 1406 | valve spring guide |
| 1411 | valve spring |
| 1412 | impact spring |
| 1413 | valve spring plate |
| 1414 | conical piece |
| 1415 | bracing ring |
| 1416 | retaining ring |
| 3020 | heat exchanger head plate |
| 3021 | flange |
| 3022 | mounting hole |
| 3023 | matrix |
| 3024 | pipe seat |

1-67. (canceled)

68. Axial-piston engine with a compressor stage comprising at least one cylinder, with an expander stage comprising at least one cylinder, with at least one combustion chamber between the compressor stage and the expander stage, wherein the compressor stage has a stroke volume different from the expander stage.

69. Axial-piston engine according to claim 68, wherein the stroke volume of the compressor stage is smaller than the stroke volume of the expander stage.

70. Axial-piston engine according to claim 68, wherein an individual stroke volume of at least one cylinder of the compressor stage is smaller than the individual stroke volume of at least one cylinder of the expander stage.

71. Axial-piston engine according to claim 68, wherein the number of cylinders of the compressor stage is equal to or smaller than the number of cylinders of the expander stage.

72. Axial-piston engine with a compressor stage comprising at least one cylinder, with an expander stage comprising at least one cylinder, with at least one combustion chamber between the compressor stage and the expander stage, with at least one control piston as well as a channel between the combustion chamber and the expander stage, wherein the control piston and the channel have a flow cross section with a main flow direction released by movement of the control piston, wherein the control piston has a guide face parallel to the main flow direction.

73. Axial-piston engine with a compressor stage comprising at least one cylinder, with an expander stage comprising at least one cylinder, with at least one combustion chamber between the compressor stage and the expander stage, with at least one control piston as well as a channel between the combustion chamber and the expander stage, wherein the control piston and the channel have a flow cross section with a main flow direction released by movement of the control piston, wherein the control piston has an impact face perpendicular to the main flow direction.

74. Axial-piston engine with a compressor stage comprising at least one cylinder, with an expander stage comprising at least one cylinder, with at least one combustion chamber between the compressor stage and the expander stage, with at least one control piston as well as a channel between the combustion chamber and the expander stage, wherein the control piston and the channel have a flow cross section released by movement of the control piston and the movement of the control piston takes place along a longitudinal axis of the control piston, wherein the control piston has a guide face at an acute angle to the longitudinal axis of the control piston.

75. Axial-piston engine with a compressor stage comprising at least one cylinder, with an expander stage comprising at least one cylinder, with at least one combustion chamber between the compressor stage and the expander stage, with at least one control piston as well as a channel between the combustion chamber and the expander stage, wherein the control piston and the channel have a flow cross section released by movement of the control piston and the movement of the control piston takes place along a longitudinal axis of the control piston, wherein the control piston has an impact face at an acute angle to the longitudinal axis of the control piston.

76. Axial-piston engine according to claim 72, wherein the guide face and/or the impact face is a planar face, a spherical face, a cylindrical face or a conical face.

77. Axial-piston engine according to claim 72, wherein the axial-piston engine has a guide-face sealing face between the combustion chamber and the expander stage, wherein the guide-face sealing face is formed parallel to the guide face and cooperates with the guide face at a top dead point of the control piston.

78. Axial-piston engine according to claim 77, wherein the guide-face sealing face merges on the channel side into a surface perpendicular to the longitudinal axis of the control piston.

79. Axial-piston engine according to claim 68, comprising internal continuous combustion (icc).

80. Axial-piston engine according to claim 72, comprising internal continuous combustion (icc).

81. Axial-piston engine according to claim 73, comprising internal continuous combustion (icc).

82. Axial-piston engine according to claim 74, comprising internal continuous combustion (icc).

83. Axial-piston engine according to claim 75, comprising internal continuous combustion (icc).
